(19) United States
(12) Patent Application Publication
(10) Pub. No.: US 2009/0194989 A1
(43) Pub. Date: Aug. 6, 2009

(54) Duct coupling adjustment and thrust load restraint system

(76) Inventor: Kenneth P. Krohn, Oceanside, CA (US)

Correspondence Address: LAW OFFICE OF KENNETH P. KROHN,;A PROFESSIONAL LAW CORPORATION, POST OFFICE BOX 4415, CARLSBAD, CA, 92018, US

(21) Appl. No.: 12/012,954

(22) Filed: Feb. 6, 2008

(51) Int. Cl. F16L 55/18; F16L 17/00; B29C 65/00

(52) U.S. Cl. 285/16; 285/104; 156/443; 156/215

(57) ABSTRACT

The present invention generally relates to a wrap member that is used with compression connectors, such as compression couplings and fittings that may be connected to one size of duct (such as pipe or tubing) or multiple sizes and shapes of ducts. The wrap member may be connected to the duct so that the wrap member abuts against a portion of the connector, holding the connector and the duct in place against any thrust loads that tend to push the duct out from the connector. The wrap member may also be positioned between the duct and a compression member (such as a ferrule) that comprises the compression connector, so that a fluid-tight seal is formed between the duct, the compression member, and the wrap member. This allows the compression connector to be connected to ducts that are smaller than the size of duct for which the connector is designed.

### BACKGROUND

There exist in the relevant art apparatus that are used to permanently or removably connect the apparatus to a duct (such as a length of pipe or tubing), in which the apparatus maintains a fluid tight seal between portions of the apparatus and the exterior surface of the duct by means of a compression member being held in place against the exterior surface of the duct. Such apparatus are sometimes referred to as a “compression connector” herein. For example, a pipe fitting, which is also sometimes referred to as a “compression fitting” in the relevant art, may have a tubular rigid or semi-rigid member (such as a ferrule) that is slipped over the exterior surface of a pipe. The pipe is then inserted into the fitting, and the tubular compression member is compressed against the pipe's exterior surface by the interior surfaces of the fitting, forming a fluid-tight seal between the pipe and the fitting. The present invention generally relates to a device that permits the apparatus (such as the pipe fitting) to be used with different sizes of ducts (such as the pipe) other than the size of duct originally designed to be used with the apparatus. In addition, the present invention generally relates to a device that assists in holding the duct in place relative to the apparatus. For example, when the system (apparatus and duct) is operating under pressure, thrust loads are created that tend to push the duct and the apparatus apart. The present invention is adapted to hold the pipe in place relative to the apparatus against such thrust loads.

As an example for purposes of discussion, a typical type of compression connector (which is by no means exclusive) may use a tubular compression member that is designed to fit tightly against the exterior surface of a duct to which the apparatus is to be connected. Narrowing the example further, the compression connector may be comprised of a pipe coupling that is designed to connect two lengths of pipe together. In this case, the coupling may be comprised of two tubular compression members, each of which is designed to slip over and fit tightly against the exterior surface of each of the pipes near their respective ends. As a result, the compression member is designed to be used, and may only be used, for pipes having a particular diameter or relatively narrow range of diameters. The end of each length of pipe is inserted into an interior space at each end of the coupling. The interior space is generally bounded by a casing sidewall that conforms to the expected size and shape of the pipes for which the coupling is designed. Typically, as described in more detail below, an end cap that fits over the pipe and the compression member is then screwed down onto the casing. The geometry of the interior surfaces of the casing and the end cap is such that as the end cap is screwed onto the casing, the compression member is compressed against the pipe, so that it is forced even tighter against the exterior surface of the pipe. This compression causes a seal to be formed between the coupling and the pipe that is intended to be fluid-tight over the anticipated range of operating pressure (the pressure within the pipes and interior space of the coupling) of the coupling-pipe system.

This type of pipe coupling (as an example of a compression connector) often has several disadvantages. For example, because the compression members of the coupling are designed for use with only a particular size (or narrow range of sizes) of pipe, the coupling can only be used with the particular size (or sizes) of pipe. If the user desires to use the coupling to connect two pipes of different sizes, he or she must often use other types of fittings (such as bushings and adapters) to reduce or enlarge the size of one or both of the pipes so that they can be used with the coupling. Alternatively, the user must procure another coupling of a different size. In either case, the user may incur additional expense in purchasing additional bushings or adapters or a replacement coupling designed to be used with different sizes of pipe. This may also cause the user to make additional trips to the supply warehouse or store, creating additional expense and wasted time. Thus, there is a need for a device that may be used to easily and inexpensively adapt the coupling or the pipe or both so that the coupling may be used with more than one size of pipe. In addition, there are times that the compression member does not fit well against the exterior surface of the pipe because of corrosion (such as rust) present on the surface. In such cases, there is a need for a device that may be used to easily and inexpensively adapt the coupling or the pipe or both in order to form a fluid-tight seal between the coupling and the pipe.

In addition, for compression couplings that operate under pressure, as the pressure within the coupling and the connected pipes increases, increasing thrust loads are typically created as well. These thrust loads are generally manifested as forces along the longitudinal axes of the pipes that tend to push the pipes out away from the coupling. Because the friction created by the compression of the pipe against the compression member is typically the only force that holds the pipe in place in the coupling, if the pressure becomes too great, one or more of the pipes may blow out from the coupling. This results in failure of the fluid-tight seal between the coupling and such pipe or pipes, which also results in failure of the connection. In order to prevent this failure, it may be necessary to spend time, effort and money to construct means to secure the ducts or the compression connector or both. Thus, there is also a need for a device that may be used to easily and inexpensively hold the pipe in place within the coupling so that forces resulting from thrust loads do not blow the pipe out of the coupling.

It is to be noted that other types of compression connectors may be comprised of variable connecting means designed for use with different sizes and shapes of ducts (such as pipes and tubing). Examples of these types of compression connectors are disclosed in U.S. Nonprovisional patent application Ser. Nos. 11/522,607 filed on Sep. 18, 2006, and 11/879,346 filed on Jul. 17, 2007, and U.S. Provisional Patent Application No. 60/______, entitled DEVICE FOR CONNECTING TO DUCTS OF VARIOUS SIZES AND SHAPES, filed on Jan. 25, 2008, which also name as inventor the inventor of the present invention. The entire disclosure of each of these patent applications is incorporated herein by this reference. Even these types of compression connector may have limitations. In circumstances where it is desirable to connect a duct to a compression connector comprised of variable connecting means that is beyond the applicable design range, it may be difficult to do so. For example, if the design range of the compression connector is for ½″ to ¾″ male iron pipe (MIP) ducts, it is generally not possible connect a ¼″ MIP duct to the compression connector without some type of additional adapting means. Thus, it is desirable to have a simple, inexpensive and easy to use means to allow the smaller duct to be connected to the variable connecting means of the compression connector. In addition, if the operating pressure within the compression connector becomes too great, the resulting thrust loads may approach or exceed the design limits of the compression connector. In such cases, it may also be desirable to have a means that provides additional reinforcement against such thrust loads to prevent failure of the device.

It is to be noted that the device of the present invention is not limited to use with lengths of pipe and tubing alone. It may also be used with other types of ducts, such as conduit, tubing (including medical or food grade tubing), pipeline, hose, channel, vent, a container spout, or other similar ducts or combinations of such ducts, including those having different cross-sectional shapes (such as square or hexagonal). It is also to be noted that the device of the present invention may be used for ducts transporting gases or liquids or both, so that references to a “fluid” herein are intended to refer to both gases and liquids.

### SUMMARY

The present invention is directed to a device and methods of using the device that meet the needs discussed above in the Background section. As described in greater detail below, the present invention, when used for its intended purposes, has many advantages over other devices known in the art, as well as novel features that result in a new device and methods for its use that are not anticipated, rendered obvious, suggested, or even implied by any prior art devices or methods, either alone or in any combination thereof.

In a preferred embodiment, a device is disclosed for use with a compression connector and a duct that is adapted to be connected to the compression connector. The compression connector is further comprised of a compression member that is adapted to be positioned adjacent to the exterior surface of the duct. The compression member is also adapted to form a fluid-tight seal between the compression connector and the duct. In this embodiment, the device is generally comprised of wrap means and wrap connecting means, both of which are described in more detail below. In some embodiments, the wrap means may be comprised of thrust load restraint means, which are adapted to hold the duct in place relative to the compression connector against thrust loads created when pressure is present in the compression connector and the duct. In such cases, the wrap means may be further comprised of a wrap member that is adapted to be positioned adjacent to a portion of the exterior surface of the duct. The wrap member abuts against a portion of the compression connector in a manner adapted to hold the duct in place relative to the compression connector against thrust loads created when pressure is present in the compression connector and the duct. In other embodiments, the wrap means may be further comprised of size adjusting means, which are adapted to allow ducts to be connected to the compression connector that are generally smaller than the duct size or sizes for which the compression connector has been designed. In such cases, the wrap means may be further comprised of a wrap member that is positioned between a portion of the exterior surface of the duct and all or a portion of the compression member so that a fluid-tight seal is adapted to be made between the exterior surface of the duct, the wrap member, and the compression member. In still other embodiments, the wrap means may be comprised of both thrust load restraint means and size adjusting means. The wrap connecting means connect the wrap means to a portion of the exterior surface of the duct. In some embodiments, the device further comprises the compression connector or the duct or both.

The compression connector may generally be any type of connector that is comprised of a casing member and a compression member, where the connector may be used to connect to one or more ducts. The compression member is used to form a fluid-tight seal between the connector and the duct. For example, the compression member may be a tubular ring that is designed to fit tightly against the exterior surface of the duct. The tubular ring may be comprised of a semi-rigid material (such as rubber) or a rigid material (such as copper or brass). In other cases, the compression member may be comprised of a ferrule that is used to secure a fluid-tight joint between the connector and the duct. The ferrule may also be comprised of semi-rigid or rigid materials. In operation, the compression member is typically compressed between the exterior surface of the duct and the interior surface of the casing member. This compression forms or enhances the fluid-tight seal between the compression member and the duct. Other types of compression connectors may be comprised of variable connecting means designed for use with different sizes and shapes of ducts (such as pipes and tubing). Examples of these types of compression connector are disclosed in U.S. Nonprovisional patent application Ser. Nos. 11/522,607 filed on Sep. 18, 2006, and 11/879,346 filed on Jul. 17, 2007, and U.S. Provisional Patent Application No 60/______, entitled DEVICE FOR CONNECTING TO DUCTS OF VARIOUS SIZES AND SHAPES, filed on Jan. 25, 2008, which also name as inventor the inventor of the present invention. The entire disclosure of each of these patent applications is incorporated herein by this reference. In these cases, the duct exterior surface has a variable size and shape within a predetermined range. For example, the ducts that may be connected to the connector may be tubular in shape and have an outside diameter in the range of 0.84″ to 1.05″. In addition, the variable connecting means may be comprised of: (1) a casing member, (2) a sealing member or duct sealing means, and (3) seal supporting means, a support assembly, or internal support means to hold the sealing member in place relative to the duct and the connector. A portion of the sealing member is forced against the exterior surface of the duct around its perimeter, which preferably forms a fluid-tight seal between the connector and the duct. Some of these types of compression connectors are described in more detail below.

In another embodiment, the present invention is comprised of a wrap member that is adapted to be positioned on and connected to a portion of the exterior surface of the duct. The compression connector is further comprised of a compression member that is adapted to form a fluid-tight seal between the compression connector and the duct, and a portion of the wrap member abuts against a portion of the compression member in a manner that is adapted to hold the duct in place relative to the compression connector against thrust loads created when pressure is present in the compression connector and the duct. The wrap member may be comprised of a ribbon that is further comprised of a semi-rigid portion, which is adapted to be positioned on the exterior surface of the duct by wrapping the ribbon around all or a portion of the periphery of the duct. A method of using this device comprises connecting the wrap member to the exterior surface of the duct.

In yet other embodiments, the present invention is comprised of wrap means and wrap connecting means for connecting the wrap means to a portion of the exterior surface of the duct, both of which means are described in more detail below. The wrap means are adapted for holding the duct in place relative to the compression connector against thrust loads created when pressure is present in the compression connector and the duct. The wrap means may be comprised of a ribbon, which is further comprised of a semi-rigid portion. The ribbon is adapted to be positioned on a portion of the exterior surface of the duct by wrapping the ribbon around all or a portion of the periphery of the duct. Alternatively, the wrap means may be comprised of a collar member that is adapted to be positioned on a portion of the exterior surface of the duct by sliding the collar member over the end of the duct. In some embodiments, the wrap connecting means may be comprised of an adhesive or an adhesive tape with a peal-off strip. A method of using the wrap means and wrap connecting means comprises connecting the wrap means to a portion of the exterior surface of the duct using the wrap connecting means. A kit for use with the compression connector may comprise the wrap means and the wrap connecting means.

In still other embodiments, the present invention is comprised of a device for use with a compression connector and a first duct that is adapted to be connected to the compression connector. The device comprises a wrap member that is adapted to be positioned on a portion of the exterior surface of the first duct. The compression connector is further comprised of a compression member that is adapted to be positioned on and compressed against the exterior surface of at least one second duct having an outside cross-sectional perimeter larger than that of the first duct. The wrap member is positioned between a portion of the exterior surface of the first duct and all or a portion of the compression member in a manner adapted to create a fluid-tight seal between the exterior surface of the first duct, the wrap member, and the compression member. In various embodiments, the wrap member may be comprised of a ribbon that is adapted to be positioned on the exterior surface of the first duct by wrapping the ribbon around all or a portion of the perimeter of the first duct or a collar member that is adapted to be positioned on the exterior surface of the first duct by sliding the collar member over the end of and along the longitudinal axis of the first duct. A method of using this device comprises positioning the wrap member on a portion of the exterior surface of the first duct and then positioning all or a portion of the compression member adjacent to all or a portion of the wrap member. The wrap member may also be adapted so that a portion of the wrap member abuts against a portion of the compression connector in a manner that is adapted to hold the first duct in place relative to the compression connector against thrust loads created when pressure is present in the compression connector and the first duct. A kit may also comprise the wrap member and the compression connector.

Another embodiment of the present invention discloses a device comprised of size adjusting means and wrap connecting means, both of which are described in more detail below. The size adjusting means are adapted to be positioned between a portion of the exterior surface of the duct and all or a portion of the compression member so that a fluid-tight seal is adapted to be made between the exterior surface of the duct, the wrap member, and the compression member. The wrap connecting means are for connecting the size adjusting means to a portion of the exterior surface of the first duct. The size adjusting means may be comprised of a ribbon similar to those summarized above and described in more detail below. The wrap connecting means may be comprised of an adhesive or an adhesive tape with a peal-off strip. A kit for use with the compression connector may also comprise the size adjusting means and the wrap connecting means.

Yet another embodiment of the present invention discloses a device for connecting to at least one duct, where the at least one duct comprises a duct open end and a duct exterior surface adjacent to the duct open end having a size and shape within a predetermined range. The device comprises a casing member, a variable connecting member, variable member connecting means, wrap means, and wrap connecting means, all of which are described in more detail below. The casing member is comprised of a casing interior space and at least one casing duct opening adjoining the casing interior space. The variable connecting member is positioned approximately within the at least one casing duct opening and is further comprised of duct sealing means and seal support means, both of which are described in more detail below. The duct sealing means are adapted for changing shape to conform to the shape of and being positioned adjacent to the duct exterior surface while the at least one duct is connected to the device. The seal support means are adapted for permitting a portion of the duct sealing means to change shape to conform to the shape of the duct exterior surface and adapted for holding the duct sealing means, the case body, and the at least one duct operatively in place relative to one another while the at least one duct is connected to the device. The variable member connecting means are for permanently or removably connecting the variable connecting member to the casing member. The wrap means and wrap connecting means may be similar to any of those summarized above and described in more detail below.

The present invention therefore meets the needs described above in the Background section. For example, the present invention may be used to hold a duct in place relative to a compression connector against thrust loads within the duct and connector that tend to push the pipe and connector apart. In addition, the present invention may be used to connect ducts having a relatively smaller exterior dimension to compression connectors that are designed for use with larger sized ducts. In some embodiments, the present invention may accomplish both functions simultaneously. Thus, the present invention may save time and expense for users of compression connectors in certain circumstances, as described in more detail in the above Background section.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following description, will be better understood when read in conjunction with the appended drawings, in which:

FIG. 1A is a partially exploded perspective view of an embodiment of a device of the present invention, as viewed from the side of and above the device.

FIG. 1B is a plan view of the embodiment of the device illustrated in FIG. 1, as viewed from above one end of the device.

FIG. 1C is a sectional view of the embodiment of the device illustrated in FIG. 1A and FIG. 1B, as taken along the lines 1C-1C in FIG. 1B.

FIG. 2 is an elevation view of an embodiment of the wrap means illustrated in FIG. 1A through FIG. 2 prior to its attachment to the duct, as viewed from the side of the wrap means.

FIG. 3A is a perspective view of another embodiment of wrap means, as positioned on the duct, and as viewed from the side of and above the wrap means.

FIG. 3B is a plan view of the embodiment of the wrap means illustrated in FIG. 3A, as viewed from above one end of the wrap means.

FIG. 3C is a sectional view of the embodiment of the wrap means illustrated in FIG. 3A and FIG. 3B, as taken along the lines 3C-3C in FIG. 3B, and a perspective view of a container holding wrap connecting means intended for use with the wrap means.

FIG. 4 is an elevation view of another embodiment of wrap means prior to its attachment to the duct, as viewed from the side of the wrap means.

FIG. 5 is a perspective view of another embodiment of wrap means, as positioned between the duct and the compression member, and as viewed from the side of and above the wrap means.

FIG. 6 is a perspective view of the embodiment of the wrap means illustrated in FIG. 5 prior to its attachment to the duct, as viewed from the side of and above the wrap means.

FIG. 7 is a perspective view of another embodiment of wrap mean prior to its attachment to the duct, as viewed from the side of and above the wrap means.

FIG. 8 is an enlarged, partial perspective view of an embodiment of the wrap means, as viewed from the side of and above the wrap means.

FIG. 9 is a perspective view of another embodiment of wrap means, as positioned between the duct and the compression member, and as viewed from the side of and above the wrap means.

FIG. 10A is a perspective view of an embodiment of a compression connector comprising variable connecting means, as viewed from the side of and above the compression connector, the compression connector generally comprising a coupling.

FIG. 10B is a partially exploded perspective view of the embodiment of the compression connector illustrated in FIG. 10A, as viewed from the side of and above one end of the compression connector.

FIG. 11 is an exploded perspective view of an embodiment of a variable connecting member, which is a part of the embodiment of the compression connector illustrated in FIG. 10A and FIG. 10B, as viewed from the side of and above the variable connecting member.

FIG. 12A is a perspective view of an embodiment of an internal seal member, which is a part of the embodiment of the variable connecting member illustrated in FIG. 11, as viewed from the side of and above the internal seal inlet of the internal seal member.

FIG. 12B is a perspective view of the embodiment of the internal seal member illustrated in FIG. 12A, as viewed from the side of and above the internal seal outlet of the internal seal member.

FIG. 12C is a perspective view of another embodiment of an internal seal member, as viewed from the side of and above the internal seal outlet of the internal seal member.

FIG. 13A is a perspective view of an embodiment of an external seal member, which is a part of the embodiment of the variable connecting member illustrated in FIG. 11, as viewed from the side of and above the external seal outlet of the external seal member.

FIG. 13B is a perspective view of the embodiment of the external seal member illustrated in FIG. 13A, as viewed from the side of and above the external seal inlet of the external seal member.

FIG. 14 is a perspective view of an embodiment of an internal support structure, which is a part of the embodiment of the variable connecting member illustrated in FIG. 11, as viewed from the side of and above the internal support flange member of the internal support structure.

FIG. 15A is a plan view of an embodiment of an external support structure, which is a part of the embodiment of the variable connecting member illustrated in FIG. 11, as viewed from above the external support flange member of the external support structure.

FIG. 15B is a perspective view of the embodiment of the external support structure illustrated in FIG. 15A, as viewed from the side of and above the distal end of the external support structure, which is the end opposite of that illustrated in FIG. 15A.

FIG. 15C is a perspective view of the embodiment of the external support structure illustrated in FIG. 15A and FIG. 15B, as viewed from the side of and above the external support flange member of the external support structure.

FIG. 16A is a perspective view of one duct and its corresponding wrap means, which are used with the compression connector illustrated in FIG. 17A and FIG. 17B, as viewed from the side of and above the duct and wrap means.

FIG. 16B is a perspective view of the other duct and its corresponding wrap means, which are used with the compression connector illustrated in FIG. 17A and FIG. 17B, as viewed from the side of and above the duct and wrap means.

FIG. 17A is a plan view of the embodiment of the compression connector illustrated in FIG. 10A and FIG. 10B, as viewed from above one end of the compression connector, the compression connector being connected to embodiments of two ducts, each of which are used in connection with wrap means.

FIG. 17B is a sectional view of the embodiment of the device illustrated in FIG. 17A, as taken along the lines 17B-17B in FIG. 17A, such sectional view also illustrating connection of the compression connector to embodiments of two ducts, each of which are used in connection with wrap means; and (2) a perspective view of supplemental duct sealing means intended for use with the device.

### DETAILED DESCRIPTION

Reference will now be made in detail to the preferred aspects, versions and embodiments of the present invention, examples of which are illustrated in the accompanying drawings. While the invention will be described in conjunction with the preferred aspects, versions and embodiments, it is to be noted that the aspects, versions and embodiments are not intended to limit the invention to those aspects, versions and embodiments. On the contrary, the invention is intended to cover alternatives, modifications, portions and equivalents, which may be included within the spirit and scope of the invention as defined by the appended claims.

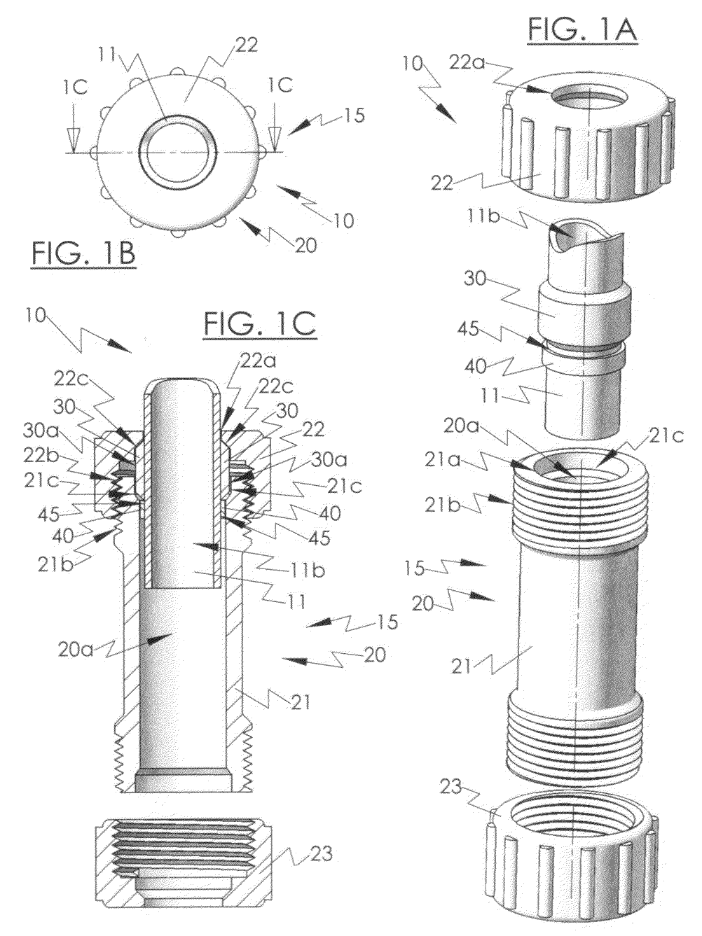

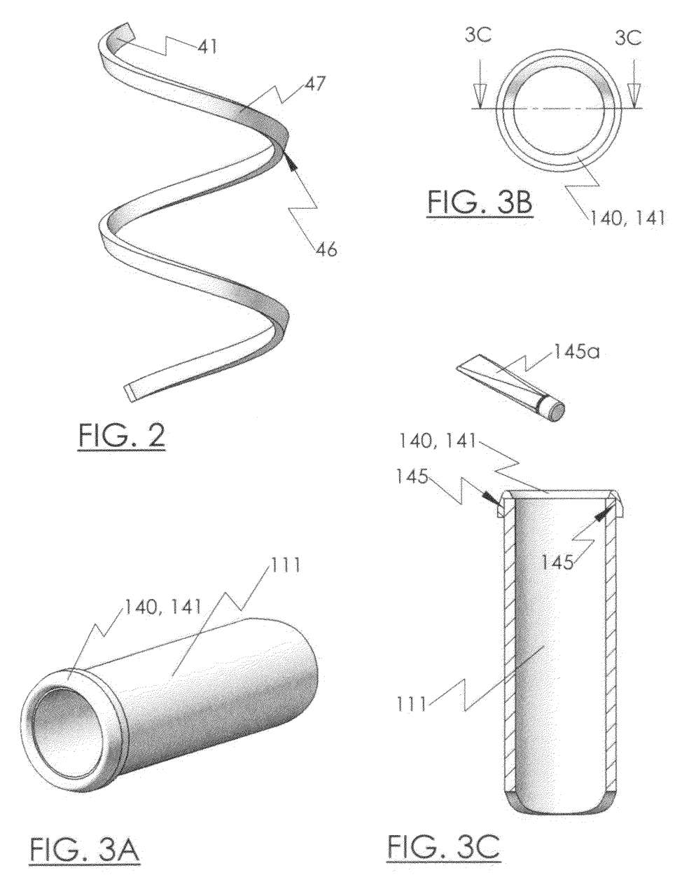

One embodiment of the present invention 10 is illustrated in FIG. 1A through FIG. 2. FIG. 1A presents a partially exploded view of the device 10, FIG. 1B presents a plan view from above one end of the device 10, and FIG. 1C presents a sectional view of the device 10. The device 10 may be used for connecting to one or more ducts (such as pipe 11). In this embodiment, the device 10 is generally comprised of a compression connector 15 and wrap means (wrap member 40 in this embodiment), which are both described in more detail below. In some embodiments, the present invention may be comprised of the wrap means (wrap member 40) alone, while in other embodiments the present invention may comprise the wrap means (wrap member 40) along with the compression connector 15 or the duct (pipe 11) or both.

Although the duct (pipe 11) illustrated in FIG. 1A and FIG. 1B has a tubular shape, the duct (pipe 11) may be comprised in whole or in part of conduit, tubing (including medical or food grade tubing), pipeline, duct, hose, channel, vent or other similar objects or combinations of such objects that may be currently known in the relevant art or that may be developed in the relevant art in the future. The duct (pipe 11) may also have other shapes in other embodiments. For example, the duct (pipe 11) may have a cross-section that is approximately elliptical, triangular, square, rectangular, pentagonal, hexagonal, another polygonal shape, or another shape or combination of such shapes. The duct (pipe 11) may also be comprised of any materials suitable for constructing conduit, tubing, pipeline, duct, hose, channel, vent or similar objects. Examples include metals (such as steel, steel alloys, aluminum, copper, brass, or other metals or metal alloys), polymers (such as polyvinyl chloride (PVC), polyethylene, acrylonitrile butadiene styrene (ABS), rubber, synthetic rubber (including NEOPRENE), silicon, and other polymers), wood, glass, fiberglass, carbon-based and other composites, or other materials or a combination of such materials. It is also to be noted that the device 10 of the present invention may be used for ducts (pipe 11) transporting gases or liquids or both, so that references to a “fluid” herein are intended to refer to both gases and liquids. In various embodiments, the device 10 may also be used to connect one or more ducts (pipe 11), as described in more detail below.

In the embodiment of the device 10 illustrated in FIG. 1A through FIG. 1C, the compression connector 15 is further comprised of a casing member 20 and compression connecting means (further comprising compression member 30 in this embodiment), which are described in more detail below. The casing member 20 is further comprised of a hollow, approximately tubular-shaped case body 21 and a case cap 22, 23 positioned at each end of the case body 21. Case cap 23 may have any of the characteristics, features, structure, functions and operation as case cap 22, as described in more detail elsewhere herein. The case cap 22 has a duct opening 22a positioned therein that is of a size and shape adapted to receive the duct (pipe 11). The case cap 22 may be removably or permanently connected to the case body 21 by case cap connecting means, which are described in more detail below. Although the case body 21 is approximately tubular-shaped in the illustrated embodiment, the casing member 20 may have other shapes in other embodiments of the device 10, as long as the casing member 20 has an interior space 20a and a duct opening 22a adjoining the interior space 20a, wherein the duct opening 22a is of a size and shape adapted to receive the duct (pipe 11). In addition, the case body 21 may be comprised of any suitable type of material. For example, the case body 21 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The case body 21 may be fabricated using any suitable means. For example, a case body 21 constructed of PVC may be formed by injection molding. In the case of a device 15 designed for use with room temperature domestic potable water and capable of accommodating ducts (pipe 11) in the range of ¾″ to ½″ nominal diameter, the case body 21 is preferably tubular in shape and is constructed of PVC.

In the embodiment of the device 10 illustrated in FIG. 1A through FIG. 1C, the case cap 22 is approximately cylindrical in shape and may be permanently or removably attached to the open end 21a of the case body 21 adjacent to the case cap 22 by the case cap connecting means, which are described in more detail below. In the illustrated embodiment, which is the preferred embodiment, the case cap connecting means are comprised of threads 21b on the outside surface of the portion of the case body 21 adjacent to the open end 21a of the case body 21 and corresponding threads 22b on the interior surface of the tubular portion of the case cap 22. Thus, the case cap 22 may be placed over the open end 21a of the case body 21, and may then be screwed down onto the case body 21. The case cap 22 may have a different shape in other embodiments, as long as the case cap 22 cooperates with the case body 21 and the compression member 30 to accommodate the operation of the device 10, as described in more detail herein. The case cap 22 may generally be comprised of any materials or combinations of materials that may be used to construct the case body 21, as described in more detail above and illustrated in connection with FIG. 1A through FIG. 1C. Although the case cap 22 need not be constructed of the same material as the case body 21, the case cap 22 is preferably constructed of the same material. The case cap 22 may be fabricated using any suitable manufacturing means. For example, a case cap 22 comprised of PVC may be formed by injection molding. In addition, the case cap connecting means may be comprised of means other than the illustrated threads 21b, 22b. For example, other case cap connecting means that may be used to removably connect the case cap 22 to the case body 21 comprise clasps, clamps, clips, pins, hinges, other pivoting connectors or other types of connectors, either alone or in conjunction with one another in different combinations. Examples of case cap connecting means that may be used to permanently connect the case cap 22 to the case body 21 include adhesives, epoxies, welding, fusing, nails, screws, nuts, bolts, or other fasteners or a combination of such means. Preferably, the case cap 22 is generally of the shape illustrated in FIG. 1A through FIG. 1C and has a threaded case cap connecting means.

In the embodiment of the device 10 illustrated in FIG. 1A through FIG. 1C, the compression member 30 is tubular in shape and is positioned between the case cap 22 and the case body 21. In other embodiments, the compression member 30 may have another shape, as long as the compression member 30 cooperates with the case cap 22 and the case body 21 to accommodate operation of the device 10, as described in more detail below. For example, the compression member 30 may generally have the shape of any type of ferrule that is used with various types of compression connectors, which are well known in the relevant art or that may be developed in the relevant art in the future. In addition, the compression member 30 may be comprised of any suitable type of material. For example, as is the case in the illustrated embodiment of the device 10, the compression member 30 may be comprised of rubber, synthetic rubber (including NEOPRENE), elastomers or other flexible, semi-rigid, or rigid polymers, or combinations of such materials, along with a combination that may including cloth, fabric or other materials. In other embodiments, the compression member 30 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The compression member 30 may be fabricated using any suitable means. For example, a compression member 30 constructed of rubber may be formed by casting in a mold. In the case of a device 10 designed for use with room temperature domestic potable water and capable of accommodating ducts (pipe 11) in the range of ¾″ to ½″ nominal diameter that utilizes a case body 21 constructed of PVC, the compression member 30 is preferably tubular in shape and is constructed of rubber or synthetic rubber.

In the embodiment of the device 10 illustrated in FIG. 1A through FIG. 1C, the compression connecting means are comprised of the compression member 30 and the casing member 20 operating in a manner that utilizes compression between the casing member 20, the compression member 30, and the duct (pipe 11) in a manner adapted to form a fluid-tight seal between the compression connector 15 and the duct (pipe 11). In the illustrated embodiment, a portion of the interior surface 21c of the case body 21 and a portion of the interior surface 22c of the case cap 22 located approximately adjacent to the case body open end 21a are adapted to be positioned adjacent to at least a portion of the exterior surface 30a of the compression member 30. As the case cap 22 is screwed onto the case body 21, the interior surfaces 21c, 22c of the case body 21 and the case cap 22 impinge against the exterior surface 30a of the compression member 30, causing the compression member 30 to be compressed against the exterior surface of the duct (pipe 11). This compression is adapted to form a fluid-tight seal between the compression member 30 and the duct (pipe 11) and between the compression member 30 and the case body 21 within the designed operating pressures of the compression connector 15. The case cap 22 is typically screwed onto the case body 21 an extent that causes adequate compression to form the desired fluid-tight seal Thus, when fluid is present within the interior space 20a of the casing member 20 and the interior space 11b of the duct (pipe 11), the fluid-tight connection between the casing member 20, the compression member 30, and the duct (pipe 11) hold the fluid within such interior spaces 20a, 11a of the casing member 20 and the duct (pipe 11), so that the fluid does not escape through the spaces between the duct (pipe 11), the compression member 30, and the case body 21.

In various embodiments of the device 10, the compression connector 15 may be comprised of almost any form of connector utilizing compression sealing means. Generally, this means may include any connecting means that involves a member being compressed against the exterior surface of a duct to form a fluid-tight seal between the connector and the duct. As an example of another type of such connector, the compression member 30 may be constructed as a part of the case cap 22 or the case body 21. In these cases, the fluid-tight seal may be created by compression of only a portion of the compression member 30 against the casing member 20 and the duct (pipe 11) because the portion of the compression member 30 that is attached to the casing member 20 is typically sealed by means other than compression. In the embodiment of the device 10 illustrated in FIG. 1A through FIG. 1C, the compression connector 15 is generally in the configuration of a coupling, so that it can accommodate connection to two ducts (such as pipe 11) simultaneously. In other embodiments, the compression connector 15 may be incorporated in a variety of ways in any standard types of fittings, which may be fabricated as a part of or be attached to the compression connector 15. For example, the compression connector 15 may be fabricated as a portion of a 45 degree or 90 degree elbow, in which compression connecting means may be located at either or both openings of the elbow. As yet another example, the compression connector 15 may be fabricated as a portion of a tee, in which compression connecting means may be located at one or more openings of the tee and in combination with any other connecting means (such as a male iron pipe (MIP) or female iron pipe (FIP) connection), each being positioned in various openings of the tee that receive ducts (such as pipe 11). Similarly, the compression connector 15 may be formed to have substantially the same geometry and configuration of any type of fitting or connector that may be used to connect to ducts, with compression connecting means positioned in openings designed to receive ducts in a variety of combinations in conjunction with any other connecting means. Thus, in various embodiments, the compression connector 15 may be used to connect to one or more ducts utilizing compression connecting means or other means or both.

In the embodiment of the device 10 illustrated in FIG. 1A through FIG. 1C, the device 10 is further comprised of wrap means and wrap connecting means, both of which are described in more detail below. In the illustrated embodiment, the wrap means (wrap member 40) and wrap connecting means are adapted to hold the duct (pipe 11) in place relative to the compression connector 15 when thrust loads are present in the device. For example, as pressure within the interior space 20a of the casing member 20 and the interior space 11b of the duct (pipe 11) increases, the increasing pressure creates an increasing thrust load or force generally along the longitudinal axis of the duct (pipe 11) and the casing member 20 that tends to pull the duct (pipe 11) from the compression connector 15. For lower operating pressures, friction between the duct 11 and the compression member 30 may be enough to hold the duct (pipe 11) in place relative to the compression connector 15 against such thrust loads. As the pressure increases above a given level, however, this friction may not be sufficient and the duct (pipe 11) will be pushed out of the compression connector 15.

In the illustrated embodiment, the wrap means are comprised of a wrap member 40, which is adapted to be connected to the exterior surface of the duct (pipe 11) between the compression member 30 and the end of the duct (pipe 11) that is inserted into the compression connector 15. The wrap means (wrap member 40) are also of a size and shape so that they may fit into the interior space 20a of the casing member 20 without unduly interfering with the compression connecting means (the interior surfaces 21c, 22c of the case body 21 and case cap 22, respectively, and the exterior surface 30a of the compression member 30 in this embodiment). The wrap connecting means, which are described in more detail below, are used to connect the wrap member 40 to the duct (pipe 11). Thus, in operation of the device 10, as pressure increases within the device 10, the duct 11 may have a tendency to slide along the interior surface of the compression member 30, moving longitudinally away from the compression connector 15. If so, as the duct 11 slides along the interior surface of the compression member 30, the wrap member 40 will abut against the end of the compression member 30, as illustrated in FIG. 1C. Because the wrap member 40 is connected to the duct 11 by the wrap connecting means, the movement of the duct 11 relative to the compression member 30 is halted, which also halts the motion of the duct 11 relative to the casing member 20, and hence relative to the compression connector 15. The wrap means (wrap member 40) of this embodiment therefore acts as a thrust load restraint means.

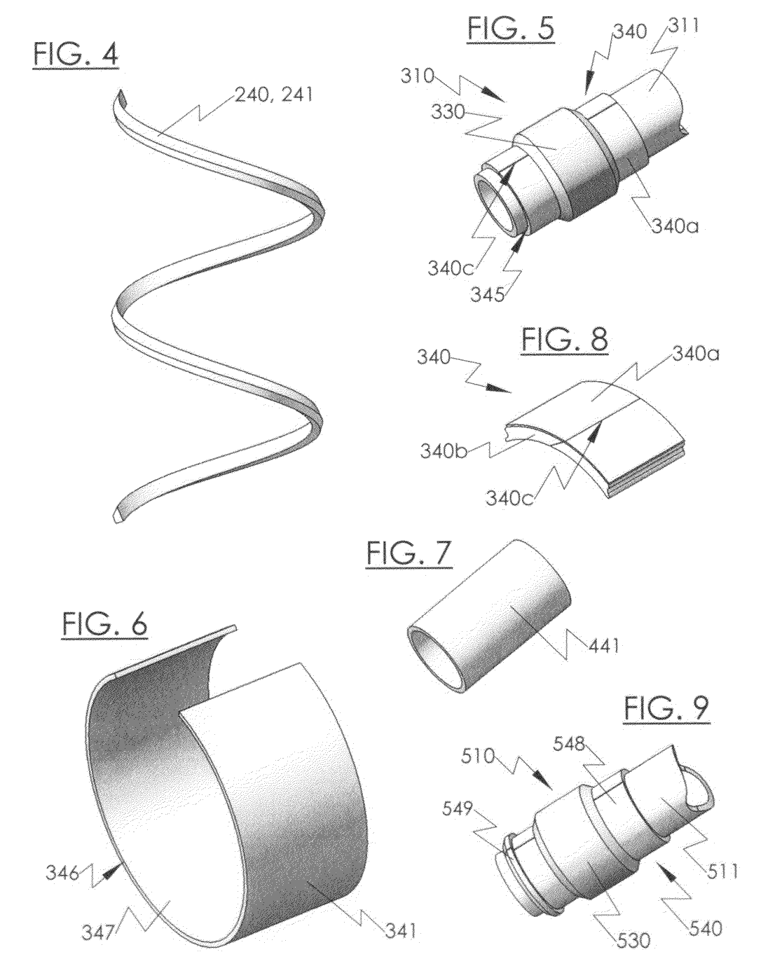

In the device 10 illustrated in FIG. 1A through FIG. 1B, the wrap member 40 is in the form of a ring having uniform width that encircles the duct 11. The wrap member 40 may have a different shape in other embodiments of the device 10. For example, the wrap member 40 may have a different width or non-uniform or varying widths in other embodiments. As another example, the wrap member 140 may have the shape illustrated in FIG. 3A through FIG. 3C. In this embodiment, the wrap member 140 is adapted to be connected to the duct 111 at the end thereof. Further, and referring again to the device 10 illustrated in FIG. 1A through FIG. 1B, although the illustrated wrap member 40 has a uniform thickness, it may be comprised of different thicknesses in other embodiments. For example, as illustrated in FIG. 4, the wrap member 240 (and its corresponding ribbon member 241, as described in more detail below) may have a cross-section shaped somewhat similar to that of a wedge. In this case, the wrap member 240 (and ribbon 241) may be positioned on the duct (not illustrated) so that the wrap member's 240 greater or lesser thickness is positioned adjacent to the compression member (not illustrated). As another example, and referring again to the device 10 illustrated in FIG. 1A through FIG. 1C, the wrap member 40 may have almost any cross-sectional shape, as long as the shape accommodates proper operation of the wrap member 40 in the device, as described in more detail herein. In addition, although the wrap member 40 is adapted to be positioned around the entire circumference of the duct 11 in the illustrated embodiment, the wrap member 40 may extend around only a portion of the duct 11 circumference in other embodiments, as illustrated in FIG. 16B by wrap member 641.

Referring to FIG. 1A through FIG. 1C, prior to its being connected to the duct 11, the wrap member 40 may take various forms. For example, the wrap member 40, 140 may be in the form of a ribbon 41, 241, as illustrated in FIG. 2 and FIG. 4, respectively. In this case, and referring again to the device 10 illustrated in FIG. 1A through FIG. 2 as an example, the ribbon 41 may be longer than is necessary to wrap completely around (or partially around) the circumference of the duct 11. If so, the ribbon 41 can be cut so that the selected and removed portion is adequate to be placed around the entire circumference of the duct 11 or around only a portion of such circumference, at the discretion of the user of the device 10. After such portion is selected and cut away from the ribbon 41, it is connected to the exterior surface of the duct 11 at the desired position utilizing the wrap connecting means, which are described in more detail below. The ribbon 41 may take almost any form prior to its connection to the duct 11. For example, the ribbon 41 may be in the form of a roll of material, such as the loose roll illustrated in FIG. 2 (and in the case of ribbon 241, as illustrated in FIG. 4). Alternative, the ribbon 41 may be in the form of strips of material. In some embodiments, the ribbon 41 may be pre-cut, so that it corresponds to the circumference of a particular size of duct 11. In these embodiments, the user of the device 10 need only select the ribbon 41 and connect it to the exterior surface of the duct 11 using the wrap connecting means (described in more detail below) without the need to measure and cut the ribbon 41. In still other embodiments, the wrap member 40 may take the form of a collar 40 having an interior surface that generally conforms to the shape of the exterior surface of the duct 11, as may also be illustrated in FIG. 1A. In these embodiments, the collar 40 may be positioned over the end of the duct 11 and then slid along the duct 11 to the desired position on the duct 11, followed by connecting the collar 40 to the duct 11 using the wrap connecting means (described in more detail below). Similarly, the wrap member 140 may take the form of a collar 140, as illustrated in FIG. 3A through FIG. 3B. In these embodiments, the collar 140 may be positioned over the end of the duct (not illustrated) and connected to the duct using the wrap connecting means (described in more detail below).

Referring again to the device 10 illustrated in FIG. 1A through FIG. 1C as an example, the wrap member 40 may be comprised of any suitable type of material. For example, as is the case for ribbons 41, the wrap member 40 (and the ribbon 41) may be comprised of any material that is flexible enough in the thickness dimension to allow the ribbon 41 to be placed around the exterior circumference of the duct 11, while having sufficient rigidity in its width dimension (the dimension along the longitudinal axis of the duct 11) to abut against the compression member 30 and halt the movement of the duct 11 relative to the compression member 30. Examples of such materials include rubber, synthetic rubber (including NEOPRENE), other elastomers or polymers (such as PVC, silicon, polyethylene, and other polymers), metal (such as copper, brass, or other metals or metal alloys), fiberglass, carbon-based or other composites, or other materials or a combination of such materials, along with a combination that may including cloth, fabric or other materials. As another example, as is the case for collars 141 illustrated in FIG. 3A through FIG. 3C, the wrap member 140 (and the collar 141) may be comprised of any material that is has sufficient rigidity in its width dimension (the dimension along the longitudinal axis of the duct 111) to abut against the compression member (not illustrated) and halt the movement of the duct 111 relative to the compression member. Examples of such materials include those disclosed for the ribbon 41, above, and may also include wood, glass, ceramic or other materials or a combination of such materials with or without the materials that may be used to comprise the ribbon 41, as described above. Preferably, and referring again to FIG. 1A through FIG. 2 as an example, the type of material comprising the wrap member 40 is compatible with the fluid that is present in the interior space 20a of the casing member 20 and the interior space 11b of the duct 11 so that the integrity of the wrap member 40 will not be materially degraded and so that the fluid within the casing interior space 20a will not become contaminated by the wrap member 40. In the case of a device 10 designed for use with room temperature domestic potable water and capable of accommodating ducts (pipe 11) in the range of ¾″ to ½″ nominal diameter that utilizes a case body 21 constructed of PVC and a compression member 30 of rubber or synthetic rubber, the wrap member 40 (as thrust force restraint means) preferably has the shape illustrated in FIG. 1A through FIG. 2 and is constructed of rubber or synthetic rubber.

In the embodiment of the device 10 illustrated in FIG. 1A through FIG. 1C, wrap connecting means are used to connect the wrap means (wrap member 40) to the exterior surface of the duct 11. The wrap connecting means may be comprised of any suitable means that are compatible with the fluid present in the interior space 20a of the casing member 20 and that permit the wrap means (wrap member 40 in this embodiment) to be connected to the duct 11 with sufficient rigidity to hold the wrap means (wrap member 40) in place against the compression member 30 within the design pressures of the device 10. For example, the wrap connecting means may be comprised of an adhesive 45 positioned on the exterior surface of the duct 11 at the location of connection to the wrap member 40 or on the surface of the wrap member 40 facing the duct 11 or both. In such cases, as illustrated in FIG. 3C, the adhesive may be within a container 145a that may or may not be included in a kit with the wrap member 40 (including ribbon 41 or collar 141 or both) or the compression connector (not illustrated) or a combination thereof. In operation, the adhesive 145 may be positioned on the duct 111 or the wrap member 140, 141 followed by positioning the wrap member 140, 141 in place on the duct 111. Referring to the ribbon 41 illustrated in FIG. 2, the adhesive 45 may also be in the form of an adhesive tape 46, which may be positioned on the ribbon 41 and covered with a peel-off strip 47 that is removed from the adhesive tape 46, exposing the adhesive tape 46, prior to attachment of the wrap member 40 (and ribbon 41) to the duct 11. The wrap member 40 is attached to the exterior surface of the duct 11 by means of the adhesive tape 46. Examples of adhesive/peel-off strips that are suitable for this purpose include 3M VHB Tapes and 3M Double Coated Tapes with release liner that are sold by the 3M Company. In various other embodiments, the wrap connecting means may be comprised of adhesive, adhesive tape, glue, epoxy, welding, fusing, clasps, clamps, fasteners or other suitable attachment means or a combination of such means. The preferred wrap connecting means for use as thrust load restraint means are an adhesive tape 46 with release liner 47 positioned on the wrap member 40 (and ribbon 41). As another example of thrust load restraint means, the adhesive may be positioned on all or a portion of the exterior surface of the duct 11 adjacent to the compression member 30, or on all or a portion of the interior surface of the compression member 30, or a combination thereof. In such cases, the adhesive may generally be applied prior to positioning of the compression member 30 on the duct 11.

The present invention also includes a method of using the device 10 illustrated in FIG. 1A through FIG. 4. Such method includes in any order: (1) positioning the compression member 30 on the duct 11; and (2) connecting the wrap member 40 to the duct 11 using wrap connecting means, so that when thrust loads are present within the compression connector 15, the wrap member 40 is adapted to abut against the compression member 30 so that the duct 11 is not pushed out of the compression connector 15 by the thrust loads. Alternatively, the method may comprise connecting the wrap means (wrap member 40) to a portion of the exterior surface of the duct 11 using the wrap connecting means.

In some embodiments of the device 10, it may be desirable to connect a duct 11 having a smaller diameter to the compression connector 15. For example, the user of the device 10 may desire to connect a ½″ MIP pipe to a compression connector 15 designed to be connected to ¾″ MIP pipe. Wrap means may also be utilized to accomplish this type of connection, which wrap means may also be considered to be size adjusting means herein. For example, as illustrated in FIG. 5, the wrap means may be comprised of a wrap member 340 that is positioned between the compression member 330 and the duct 311. In this embodiment, wrap connecting means, which are described in more detail below, are used to connect the wrap means (wrap member 340) to the exterior surface of the duct 311. Preferably, the thickness of the wrap member 340 is such that the compression member 330 fits as tightly against the exterior surface of the wrap member 340 when the wrap member 340 is positioned on the duct 311 as the compression member 330 would fit against a duct (not illustrated) having the correct size to be connected to the compression connector (not illustrated, except for the compression member 330). For example, if the design duct size is ¾″ MIP (which has an outside diameter of 1.050 inches) and the duct 311 to be connected is ½″ MIP pipe (which has an outside diameter of 0.84 inches), the wrap member 340 would preferably have a thickness of one-half the difference in the two outside diameters (thickness of wrap member=(1.050−0.84)/2=0.105″). This would produce a duct 311/wrap member 340 combination having an outside diameter of 1.050 inches, which is the same size as the duct designed to be connected to the compression connector.

In the embodiment of the wrap means illustrated in FIG. 5, the wrap means (wrap member 340) is in the form of a ring having uniform width that encircles the duct 311. The wrap member 340 may have a different shape or size (or both) in other embodiments of the wrap means. For example, the wrap member 340 may have a non-uniform width or be of different widths in other embodiments. As another example, the wrap member 340 may have a surface area greater than that of the compression member 330, so that the wrap member 340 extends along the duct 311 beyond the ends of the compression member 330 in both directions, as illustrated in FIG. 5. Alternatively, the wrap member 340 may extend beyond the end of the compression member 330 in only one direction. In addition, the wrap member 340 may have an exterior surface area smaller than the interior surface area of the compression member 330, so that the wrap member 340 does not extend along the entire length of the compression member 330. In order to create a fluid-tight seal, however, the wrap member 340 generally extends around the entire circumference of the duct 311 and the entire circumference of at least a portion of the interior surface of the compression member 330.

Prior to its being connected to the duct 311, the wrap member 340 may take various forms. For example, the wrap member 340 may be in the form of a ribbon 341, as illustrated in FIG. 6. In this case, and referring again to the device 310 illustrated in FIG. 5 as an example, the ribbon 341 may be longer than is necessary to wrap completely around (or partially around) the circumference of the duct 311. If so, the ribbon 341 can be cut so that the selected and removed portion is adequate to be placed around the entire circumference of the duct 311. After such portion is selected and cut away from the ribbon 341, it is connected to the exterior surface of the duct 311 at the desired position utilizing the wrap connecting means, which are described in more detail below. The ribbon 341 may take almost any form prior to its connection to the duct 311. For example, the ribbon 341 may be in the form of a roll of material, such as the loose roll illustrated in FIG. 2 and FIG. 4 in the case of ribbons 41, 241, respectively. Alternatively, and referring again to FIG. 6, the ribbon 341 may be in the form of strips of material. In some embodiments, the ribbon 341 may be pre-cut, so that it corresponds to the circumference of a particular size of duct 341. In these embodiments, the user of the device 310 need only select the ribbon 341 and connect it to the exterior surface of the duct 311 using the wrap connecting means (described in more detail below) without the need to measure and cut the ribbon 341. In still other embodiments, the wrap member 340 may take the form of a collar 441 having an interior surface that generally conforms to the shape of the exterior surface of the duct 311, as may also be illustrated in FIG. 5 and FIG. 7. In these embodiments, the collar 441 may be positioned over the end of the duct 311 and then slid along the duct 311 to the desired position on the duct 311, followed by connecting the collar 441 to the duct 311 using the wrap connecting means (described in more detail below).

Referring again to the device 310 illustrated in FIG. 5 as an example, the size adjusting means (wrap means comprised of wrap member 40 in this embodiment) may be comprised of a single material, which may be any suitable type of material. For example, as is the case for ribbon 341 (as illustrated in FIG. 6), the wrap member 340 (and the ribbon 341) may be comprised of any material that is flexible enough in the thickness dimension to allow the ribbon 341 to be placed around the exterior circumference of the duct 311, while having sufficient rigidity in its thickness dimension to be compressed between the compression member 330 and the duct 311 in a manner that forms a fluid-tight seal between the compression member 330 and the duct 311 within the design pressure range of the device 310. Examples of such materials include rubber, synthetic rubber (including NEOPRENE), other elastomers or polymers (such as PVC, silicon, polyethylene, and other polymers), metal (such as copper, brass, or other metals or metal alloys), fiberglass, carbon-based or other composites, or other materials or a combination of such materials, along with a combination that may including cloth, fabric or other materials. In addition, the wrap member 340 (and the ribbon 341) may have sufficient flexibility and elasticity so that it is able to change shape to conform to surface irregularities of the duct 311 and to fill any voids in the seam 340c between the ends of the ribbon 341 as it is positioned on the duct 311. As another example, as is the case for collars 441 (as illustrated in FIG. 7), the wrap member 340 (and the collar 441) may also be comprised of any material that has sufficient rigidity in its thickness dimension to be compressed between the compression member 330 and the duct 311 in a manner that forms a fluid-tight seal between the compression member 330 and the duct 311 within the design pressure range of the device 310. Examples of such materials generally include those disclosed for the ribbon 341, above. Preferably, the type of material comprising the wrap member 340 is compatible with the fluid that is present within the compression connector (not illustrated) so that the integrity of the wrap member 340 will not be materially degraded and so that the fluid will not become contaminated by the wrap member 340.

Referring to FIG. 8, which is an enlarged partial view of the embodiment of the wrap member 340 illustrated in FIG. 5, the wrap member 340 may be comprised of two or more layers 340a, 340b of material. In this embodiment, the top layer 340a, which is the layer adjacent to the compression member 330, is comprised of a relatively rigid material, while the bottom layer 340a, which is the layer placed adjacent to the duct 311, is comprised of a more elastic material. The top layer 340a may be comprised of any material that is flexible enough in the thickness dimension to allow the ribbon 341 to be placed around the exterior circumference of the duct 311, while having sufficient rigidity in its thickness dimension to generally maintain its surface shape while the wrap member 340 is being compressed between the compression member 330 and the duct 311. Examples of such materials generally include those disclosed for the ribbon 341, above. The bottom layer 340b may be comprised of any material that is elastic enough so that it deforms slightly while the wrap member 340 is being compressed between the compression member 330 and the duct 311. Examples of such materials include soft rubber, synthetic rubber (including NEOPRENE), and other elastomers or soft polymers (such as silicon) or a combination of such materials. Thus, the top layer 340a is rigid enough so that it generally maintains its surface shape as it is being compressed against the compression member 340, while the bottom layer 340b has sufficient flexibility and elasticity that it is able to change shape to conform to surface irregularities of the duct 311 and to fill any voids in the seam 340c between the ends of the ribbon 341 as it is positioned on the duct 311. Thus, the wrap member 340 may also be used to connect the compression connector (not illustrated) to ducts 311 having uneven surfaces, such as may be the case for metal pipes that have significant rust or other corrosion present on their surfaces.

Referring to FIG. 5 and FIG. 8, the ends of the wrap member 340 (and the ribbon 341) may have various shapes that enhance the seal present at the seam 340c of the wrap member 340. For example, as illustrated in FIG. 8, the ends of the wrap member 340 (and the ribbon 341) may be angled relative to the surface of the top layer 340a, rather than extending perpendicular from such surface. This angled seam 340c may provide an enhanced ability to close the seam 340c to make it fluid-tight in some embodiments of the wrap member 340 (and the ribbon 341). In the case of a device 310 designed for use with room temperature domestic potable water and capable of accommodating ducts (pipe 311) in the range of ¾″ to ½″ nominal diameter that utilizes a case body (not illustrated) constructed of PVC and a compression member 330 of rubber or synthetic rubber, the wrap means (wrap member 340) preferably has the shape illustrated in FIG. 5 and FIG. 8, has a thin top layer 340a constructed of semi-rigid rubber or synthetic rubber, and has a bottom layer 340b constructed of soft rubber or synthetic rubber.

In the embodiment of the device 310 illustrated in FIG. 5 through FIG. 8, wrap connecting means are used to connect the size adjusting means (wrap member 340, as both ribbon 341 and collar 441) to the exterior surface of the duct 311. The wrap connecting means may be comprised of any suitable means that are compatible with the fluid present in the interior space of the casing member (not illustrated) and that permit the wrap means (wrap member 340 in this embodiment) to be connected to the duct 311 with sufficient rigidity to hold the wrap means (wrap member 340) in place against the compression member 330 within the design pressures of the device 310. For example, the wrap connecting means may be comprised of an adhesive 345 positioned on the exterior surface of the duct 311 at the location of connection to the wrap member 340 or on the surface of the wrap member 340 facing the duct 311 or both. In such cases, the adhesive may be within a container, such as the container 145a illustrated in FIG. 3C, that may or may not be included in a kit with the wrap member 340 (including ribbon 341 or collar 441 or both) or the compression connector (not illustrated) or a combination thereof. In operation, the adhesive 345 may be positioned on the duct 311 or the wrap member 340, followed by positioning the wrap member 340 in place on the duct 311. In some embodiments, an adhesive or other wrap connecting means may be applied separately to all or a portion of the seam 340c to assist in making the seam 340c fluid-tight. Referring to the ribbon 341 illustrated in FIG. 6, the adhesive 345 may also be in the form of an adhesive tape 346, which may be positioned on the ribbon 341 and covered with a peel-off strip 347 that is removed from the adhesive tape 346, exposing the adhesive tape 346, prior to attachment of the wrap member 340 (ribbon 341) to the duct 311. The wrap member 340 (ribbon 341) is attached to the exterior surface of the duct 311 by means of the adhesive tape 346. Examples of adhesive/peel-off strips that are suitable for this purpose include 3M VHB Tapes and 3M Double Coated Tapes with release liner that are sold by the 3M Company. In various other embodiments, the wrap connecting means may be comprised of adhesive, adhesive tape, glue, epoxy, welding, fusing, clasps, clamps, fasteners or other suitable attachment means or a combination of such means. In still other embodiments, the pressure of the compression member 330 against the wrap member 340 may connect the wrap member 340 to the duct 311 in the sense that the wrap member 340 is held in place against the duct 311 by the compression member 330. The preferred wrap connecting means for use as size adjusting means are an adhesive tape 346 with release liner 347 positioned on the ribbon 341.

The present invention also includes a method of using the device 310 illustrated in FIG. 5 through FIG. 8. Such method includes: (1) connecting the wrap member 340 to the duct 311 using wrap connecting means; and (2) positioning the compression member 330 on the exterior surface of the wrap member 340. Alternatively, the method may comprise: (1) positioning the wrap member 340 on a portion of the exterior surface of the duct 311; and (2) then positioning all or a portion of the compression member 330 adjacent to all or a portion of the wrap member 340.

As is illustrated in the device 510 of FIG. 9, the wrap means may combine both thrust load restraint means and size adjusting means. For example, the wrap member 540 may be comprised of a size adjusting portion 548 and a thrust restraint portion 549. In various embodiments of the wrap member 540, the size adjusting portion 548 may have substantially any of the structures, features, characteristics, functions and operation as the wrap member 340 (including corresponding ribbon 341 and collar 441) described above and illustrated in connection with FIG. 5 through FIG. 8. Also, in various embodiments of the wrap member 540, the thrust restraint portion 549 may have substantially any of the structures, features, characteristics, functions and operation as the wrap member 40 (including corresponding ribbons 41,241 and collar 141) described above and illustrated in connection with FIG. 1A through FIG. 4. Thus, the wrap member 540 works to both adjust the sizes of ducts 511 that can be connected to the compression connector (not illustrated) and to prevent the duct 511 from being pushed out of the compression connector by thrust loads present in the compression connector/duct 511 system. Although the thrust restraint portion 549 is positioned at one end of the size adjusting portion 548 in the illustrated embodiment, the thrust restraint portion 549 may be positioned on another location of the size adjusting portion 548 in other embodiments. Prior to its attachment to the duct 511, the wrap member 540 may take substantially any of the forms for ribbons 41, 241, 341 and collars 141, 441 described above and illustrated in connection with FIG. 1A through FIG. 8. In the embodiment of the device 510 illustrated in FIG. 9, wrap connecting means are used to connect the wrap means (wrap member 540) to the exterior surface of the duct 511. These wrap connecting means may be comprised of any of the wrap connecting means that may be used to connect the wrap member 340 to the duct 311, as described above and illustrated in connection with FIG. 5 through FIG. 8. The present invention also includes a method of using the device 510 illustrated in FIG. 9. Such method includes: (1) connecting the wrap member 540 to the duct 511 using wrap connecting means, so that when thrust loads are present within the compression connector (not illustrated), the thrust restraint portion 549 of the wrap member 540 is adapted to abut against the compression member 530 so that the duct 511 is not pushed out of the compression connector by the thrust loads; and (2) positioning the compression member 530 on the exterior surface of the wrap member 540.

Referring again to the devices 10, 310, 510 illustrated in FIG. 1C through FIG. 9, the wrap means (wrap members 40, 140, 240, 340, 540) may each be constructed using any suitable means. For example, a ribbon 41, 241, 341 or collar 141, 441 constructed of rubber may be cast in a mold, while a collar 141, 441 constructed of a polymer may be fabricated by injection molding. Wrap means comprised of multiple layers, such as layers 340a, 340b described in more detail above and illustrated in connection with FIG. 8, may have the layers connected by a suitable adhesive or they may be fabricated as a single component in some embodiments.

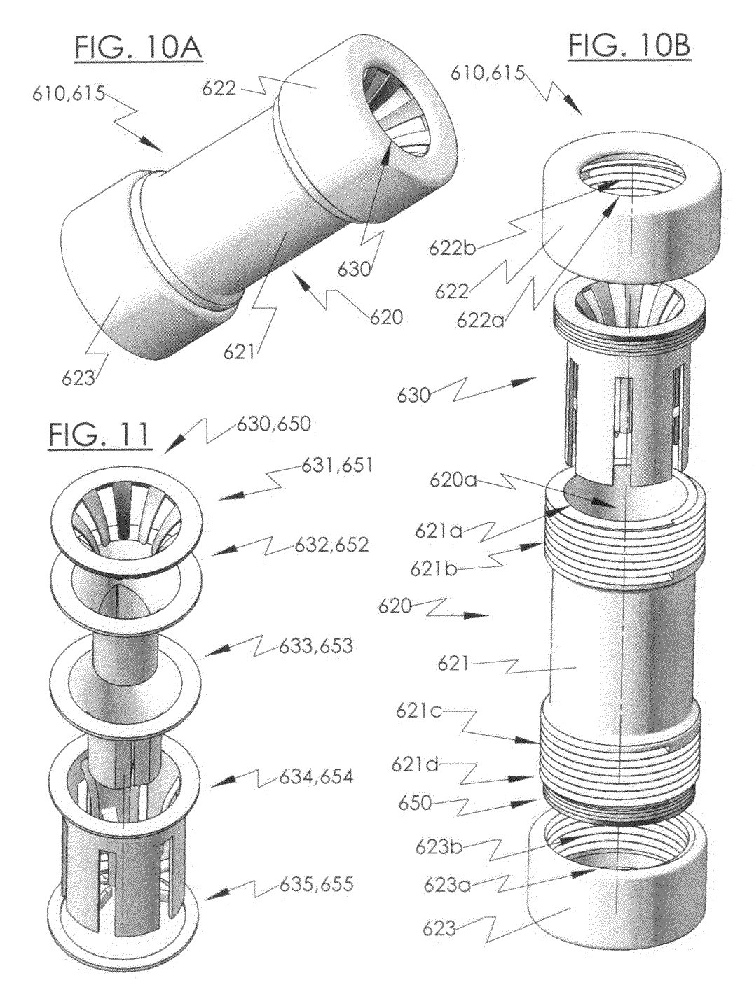

The wrap means and wrap connecting means described above in connection with the devices 10, 310, 510 illustrated in FIG. 1C through FIG. 9 may also be used in conjunction with compression connectors that utilize variable connecting means. Such variable connecting means permit the compression connector to be connected to ducts (such as pipes and tubing) having a variety of different sizes and shapes. For example, a single compression connector utilizing variable connecting means may be used to connect to a standard garden hose, a ¾″ nominal diameter steel pipe having NPT threads, or a 1″ Type L copper pipe. Examples of these types of compression connectors are disclosed in U.S. Nonprovisional patent application Ser. Nos. 11/522,607 filed on Sep. 18, 2006, and 11/879,346 filed on Jul. 17, 2007, and U.S. Provisional Patent Application No 60/______, entitled DEVICE FOR CONNECTING TO DUCTS OF VARIOUS SIZES AND SHAPES, filed on Jan. 25, 2008, which also name as inventor the inventor of the present invention. The entire disclosure of each of these patent applications is incorporated herein by this reference. It is to be noted that all of the wrap means and wrap connecting means described above in connection with the devices 10, 310, 510 illustrated in FIG. 1C through FIG. 9 may also be used in conjunction with any embodiment of all of the devices disclosed in these referenced patent applications. The use of the wrap means and wrap connecting means of the present invention in conjunction with variable connecting means is illustrated in the embodiment of the device 610 and the compression connector 615 illustrated in FIG. 10A through FIG. 17B, as described in more detail below. In these embodiments, as best illustrated in FIG. 16A, the duct 611 has a wrap member 640, acting as size adjusting means, positioned on the exterior surface thereof. In addition, as best illustrated in FIG. 16B, the duct 612 has a wrap member 641, acting as thrust load restraint means, positioned on the exterior surface thereof. In generally describing the components of the device 610, it is to be understood that general references to the ducts 611, 612 are intended to refer to the ducts 611, 612 as they may be connected to the device 610 either with or without the wrap means (wrap members 640, 641) positioned thereon.

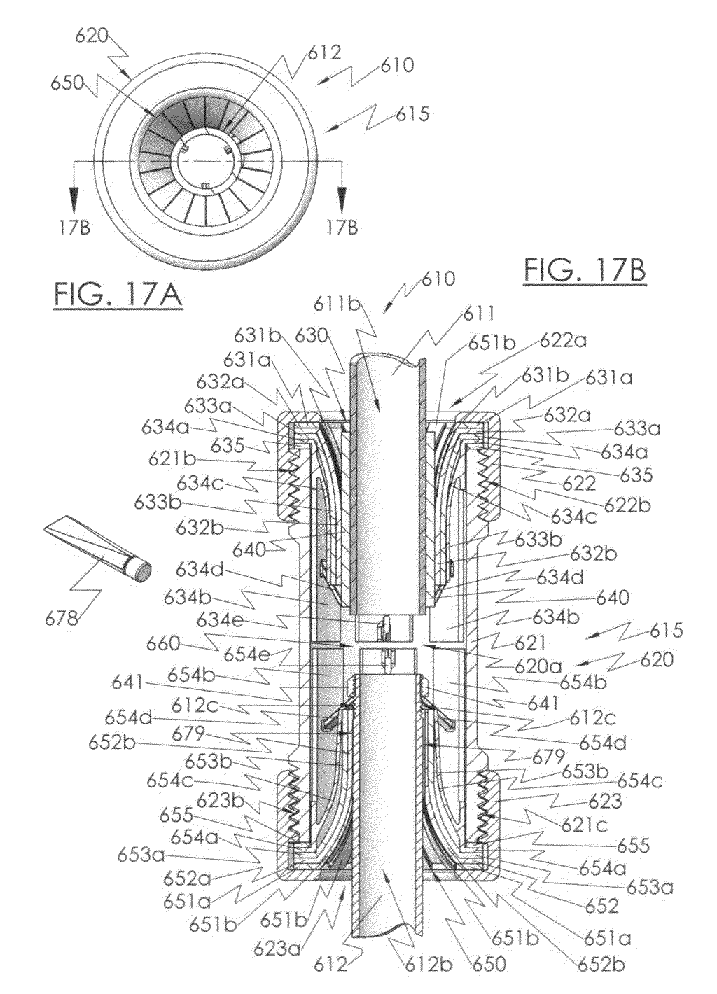

In the embodiment of the device 610 illustrated in FIG. 10A through FIG. 17B, the compression connector 615 is further comprised of a casing member 620 and variable connecting means (variable connecting members 630, 650 in the illustrated embodiment). The casing member 620 is further comprised of a hollow, approximately tubular-shaped case body 621 and a case cap 622, 623 positioned at each end of the case body 621. Case cap 623 may have any of the characteristics, features, structure, functions and operation as case cap 622, as described in more detail elsewhere herein. The case caps 622, 623 have duct openings 622a, 623a positioned therein that are of a size and shape adapted to receive the ducts (pipes 611, 612, which are illustrated in FIG. 16A through FIG. 17B, but not in FIG. 10A through FIG. 15C). The case caps 622, 623 may be removably or permanently connected to the case body 621 by case cap connecting means, which are described in more detail below. Although the case body 621 is approximately tubular-shaped in the illustrated embodiment, the casing member 620 may have other shapes in other embodiments of the device 610, as long as the casing member 620 has an interior space 620a and at least one duct opening 622a adjoining the interior space 620a, wherein the duct opening 622a is of a size and shape adapted to receive the duct (pipe 611). As an example of an alternate shape, the exterior surface of the case body 621 may be approximately elliptical, triangular, square, rectangular, pentagonal, another polygonal shape, other shapes having arcuate or linear portions, or another shape or combination of such shapes, as long as the casing member 620 cooperates with the variable connecting member 630 in operation of the device 610. Further, the case body 621 may also be comprised of two or more component parts, where such component parts are connected together by any appropriate means, such as a threaded connection, clasps, clamps, clips, pins, hinges, adhesives, epoxies, welding, fusing, nails, screws, nuts, bolts, or other types of fasteners or connectors, either alone or in conjunction with one another in different combinations. In addition, the case body 621 may be comprised of any suitable type of material. For example, the case body 621 may be comprised of metal (such as steel, steel alloys, aluminum, copper, brass, or other metals or metal alloys), polymers (such as PVC, polyethylene, polypropylene, ABS, and other polymers), wood, fiberglass, carbon-based or other composites, or other materials or a combination of such materials. The case body 621 may be fabricated using any suitable means. For example, a case body 621 constructed of PVC may be formed by injection molding. In the case of a device 610 designed for use with room temperature domestic potable water and capable of accommodating pipes 611, 612 in the range of ¾″ to ½″ nominal diameter, the case body 621 is preferably tubular in shape, is constructed of polyvinyl chloride, has an inside diameter of approximately 1½ inches, and has a wall thickness in the range of approximately ⅛ inch to 3/16 inch.

In the embodiment of the device 610 and considering the case cap 22 as an example, as best illustrated in FIG. 10A and FIG. 10B, the case cap 622 is approximately cylindrical in shape and may be permanently or removably attached to the open end 621a of the case body 621 adjacent to the case cap 622 by the case cap connecting means, which are described in more detail below. In the illustrated embodiment, which is the preferred embodiment, the case cap connecting means are comprised of threads 621b on the outside surface of the portion of the case body 621 adjacent to the open end 621a of the case body 621 and corresponding threads 622b on the interior surface of the tubular portion of the case cap 622. Thus, the case cap 622 may be placed over the open end 621a of the case body 621, and may then be screwed down onto the case body 621. In this embodiment, when the case cap 622 is screwed down onto the case body 621, a portion of the variable connecting member 630 is compressed between the case cap 622 and the case body 621, holding the variable connecting member 630 in place relative to the casing member 620 and forming a fluid-tight seal between the variable connecting member 630 and the case body 621, all as described in more detail below and as more particularly illustrated in connection with FIG. 10B and FIG. 17B. In other embodiments, the threads 621b, 622b may be oriented in a different configuration. For example, the threads 621b on the case body 621 may be positioned on the interior surface of the case body 621, and the corresponding threads 622b of the case cap 622 may be positioned on the exterior surface of a disc-shaped case cap 622. In this case, the case cap 622 is screwed into the case body 621, holding the variable connecting member 630 in place relative to the casing member 620 and forming a fluid-tight seal between the variable connecting member 630 and the case body 621 in a manner similar to that described above. Case cap 623 may be connected to the case body 621 in a similar manner utilizing the threads 621c on the case body 621 and the threads 623b on the case cap 623.

It is to be noted that in other embodiments the case cap 622 may have a different shape, as long as the case cap 622 cooperates with the case body 621 and the variable connecting member 630 to accommodate the operation of the device 610, as described in more detail herein. For example, the case cap 622 may facilitate the fluid-tight seal between the case body 621 and the variable connecting member 630 in this embodiment, as described in more detail below. In addition, the duct opening 622a may be of almost any size and shape, as long as it permits the formation of a fluid-tight seal between the variable connecting member 630 and the case body 621 in this embodiment and permits the casing member 620 to receive the duct (pipe 611), which means that the pipe 611 may be inserted into the casing member 620 and the variable connecting member 630. The case cap 622 may generally be comprised of any materials or combinations of materials that may be used to construct the case body 621, as described in more detail above and illustrated in connection with FIG. 10A and FIG. 10B. Although the case cap 622 need not be constructed of the same material as the case body 621, the case cap 622 is preferably constructed of the same material. The case cap 622 may be fabricated using any suitable manufacturing means. For example, a case cap 622 comprised of PVC may be formed by injection molding.

In addition, the case cap connecting means may be comprised of means other than the illustrated threads 621b, 622b in the case of case cap 622. For example, other case cap connecting means that may be used to removably connect the case cap 622 to the case body 621 comprise clasps, clamps, clips, pins, hinges, other pivoting connectors or other types of connectors, either alone or in conjunction with one another in different combinations. Examples of case cap connecting means that may be used to permanently connect the case cap 622 to the case body 621 include adhesives, epoxies, welding, fusing, nails, screws, nuts, bolts, or other fasteners or a combination of such means. Where the variable connecting member 630 may be positioned within the interior space 620a of the casing member 620 other than through the open end 621a of the case body 621, the case cap 622 may also be fabricated as a part of the case body 621. It is to be noted, however, that the case cap connecting means may or may not be utilized to facilitate a fluid-tight seal between the variable connecting member 630 and the case body 621. In some embodiments, a fluid-tight seal may be inherent in the type of case cap connecting means used (such as welding or fusing), or it may be created in whole or in part by additional sealing means, such as o-rings, gaskets, flanges, washers, or other similar types of means or combinations of such means, as described in more detail below. Preferably, the case cap 622 is generally of the shape illustrated in FIG. 10A and FIG. 10B and has a threaded case connecting means.

Operation of the device 610 may typically include selecting the case base 621, positioning a variable connecting member 630 approximately within the case body open end 621a, and connecting the case cap 622 to the case body 621 at the case body open end 621a utilizing the case cap connecting means. By positioning “approximately within the case body open end 621a,” it is meant that the variable connecting member 630 is generally intended to be positioned adjacent to and within the space bounded by the portion of the case body 621 adjacent to the case body open end 621a, but that in some embodiments the variable connecting member 630 may be positioned slightly above or below such case body adjacent portion or that there may be other members, such as variable member connecting means (washer 635 in the illustrated embodiment), also placed in the case body open end 621a so that the variable connecting member 630 may be slightly displaced from the case body open end 621a. Similarly, operation of the device 610 may also typically include selecting the case base 621, positioning a variable connecting member 650 approximately within the case body open end 621d, and connecting the case cap 623 to the case body 621 at the case body open end 621d utilizing the case cap connecting means.

It is to be noted that the variable connecting means (represented by the variable connecting members 630, 650 in this embodiment) working in conjunction with the casing member 620 may be incorporated in a variety of ways in any standard types of fittings, which may be fabricated as a part of or be attached to the casing member 620. For example, as illustrated in FIG. 10A and FIG. 10B, the casing member 620 may be fabricated as a portion of a compression connector 615 that acts as a coupling. In this embodiment, variable connecting means (variable connecting members 630, 650) are located at the duct opening 622a, 623a at each end of the coupling 615. Alternatively, as another example, the casing member 620 may be fabricated as a portion of a 45 degree or 90 degree elbow, in which variable connecting means may be located at either or both openings of the elbow. As yet another example, the casing member 620 may be fabricated as a portion of a tee, in which variable connecting means may be located at one or more openings of the tee and in combination with any other type of connecting means (such as an MIP or FIP connection), each being positioned in various openings of the tee that receive ducts. Similarly, the casing member 620 may be formed to have substantially the same geometry and configuration of any type of fitting or connector that may be used to connect to ducts, with variable connecting means positioned in openings designed to receive ducts in a variety of combinations in conjunction with any other type of connecting means. Further still, the casing member 620 may be comprised in whole or in part of another object (not illustrated), such as a tank, container, machine or item of equipment or any portion of the same. In such cases, the object may be connected to the casing member 620 using any suitable means or may be fabricated as a single component along with the casing member 620. Examples of such fittings and connectors are illustrated and described in U.S. patent application Ser. No. 11/879,346, the disclosure of which is incorporated herein by this reference. Thus, in various embodiments, the compression connector 615 may be used to connect one or more ducts together or to connect one or more ducts to one or more objects. As is readily apparent to one skilled in the relevant art, the variable connecting means of the compression connector 615 may be used in conjunction with almost any type of fitting or joining or coupling system currently known in the relevant art or that may be developed in the relevant art in the future.

Referring to FIG. 10B and FIG. 17B, the variable connecting members 630, 650 may have substantially the same structure, features, characteristics, functions and operation in various embodiments of the device 610. As a result, variable connecting member 630 is described below as an example, but such description is intended to apply to variable connecting member 650 as well. In the embodiment illustrated generally in FIG. 10B and FIG. 17B, the variable connecting members 630 (as an embodiment of the variable connecting means) of the device 610 is positioned within the interior space 620a of the casing member 620. The variable connecting member 630 may have a different position relative to the casing member 620 in other embodiments of the present invention. As described in more detail below, the end of the duct (pipe 611) is inserted into the device 610, so that the duct (pipe 611) extends into the variable connecting member 630 as well. In the embodiment of the variable connecting member 630 illustrated in FIG. 11, the variable connecting means are generally comprised of duct sealing means, seal support means, and variable member connecting means (comprising washer 635 in this embodiment), all of which are described in more detail below. Supplemental duct sealing means are described in more detail below in connection with the operation of variable connecting member 650, as described and illustrated in connection with FIG. 17B below. In the embodiment illustrated in FIG. 10B and FIG. 17B, the duct sealing means are generally comprised of a hollow internal seal member 632 and a hollow external seal member 633, which are described in more detail below. A fluid-tight seal is preferably formed between the exterior surface of the duct (pipe 611) and the combination of the internal seal member 632 and the external seal member 633. This seal also preferably helps prevent the duct (pipe 611) from moving relative to the internal seal member 632 and the external seal member 633 while the duct (pipe 611) is inserted into the internal seal member 632 and the external seal member 633. The supplemental duct sealing means, which are described in more detail below, may be used in some embodiments to provide or enhance the seal between the duct sealing means (internal sealing member 632 and the external sealing member 633) and the duct (pipe 611). In the embodiment of the device 610 illustrated in FIG. 10A through FIG. 11, and as best illustrated in FIG. 11, the seal support means are generally comprised of an internal support structure 631 and an external support structure 634, both of which are described in more detail below. At least a portion of the internal support structure 631 is positioned in the vicinity of the internal seal member 632, and at least a portion of the external support structure 634 is positioned in the vicinity of the external seal member 633. In addition to performing other functions, the seal support means (internal support structure 631 and the external support structure 634 in this embodiment, as described in more detail below) allow a portion of the duct sealing means (internal seal member 632 and the external seal member 633) to change shape to conform to the shape of the exterior surface at the end of the duct (pipe 611), while also providing structural support to hold the duct (pipe 611) and the duct sealing means (internal seal member 632 and the external seal member 633) in place relative to one another and the casing member 620, all as described in more detail below. The variable member connecting means, which are described in more detail below, are used to connect the variable connecting means (variable connecting member 630) to the casing member 620. It is to be noted that for purposes of operation of the present invention, the “compression member” of the variable connecting means (variable connecting members 630, 650 in this embodiment) may be comprised of the duct sealing means (internal seal members 632, 652 and external seal members 633, 653) or any of the components comprising the seal support means (internal support structure 631, 651 and external support means 634, 654). Thus, in operation of the device of the present invention, the thrust load restraint means (wrap member 640, 641 in this embodiment) may abut against any component comprising the duct sealing means (internal seal members 632, 652 and external seal members 633, 653) or the seal support means (internal support structure 631, 651 and external support means 634, 654) in order to stop the movement of the duct (pipes 611, 612) relative to the compression connector 615 in operation of the device 610. As describe above, variable connecting member 650 may have substantially the same structure, features, characteristics, function and operation as variable connecting member 630, the details of which are now described in more detail.

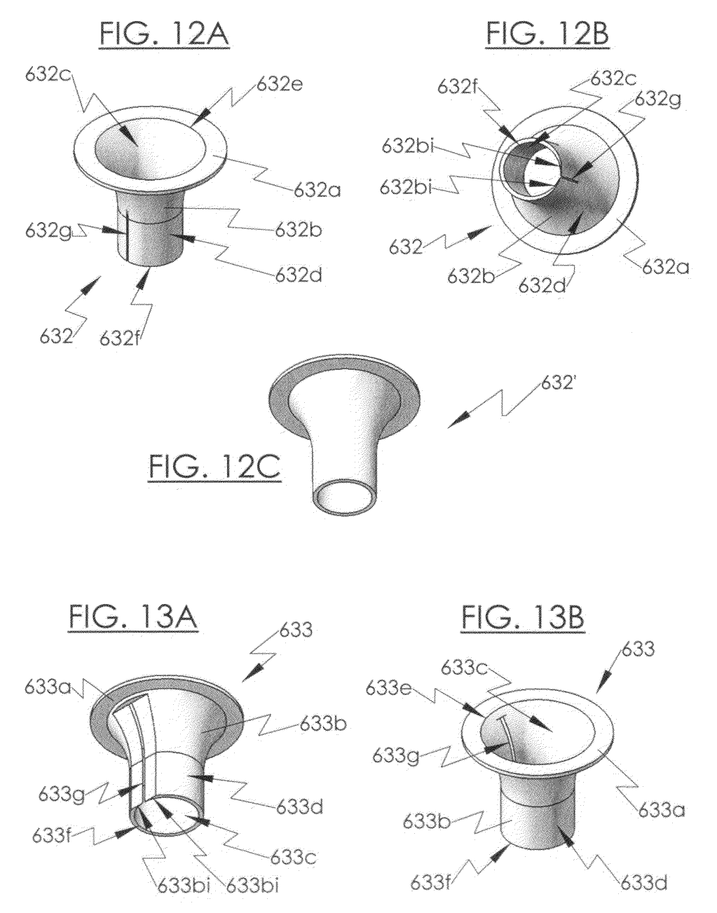

In the embodiment of the device 610 illustrated in FIG. 10B through FIG. 12B, FIG. 13A, and FIG. 13B, the duct sealing means are comprised of internal seal member 632 and external seal member 633. As best illustrated in FIG. 12A and FIG. 12B, the internal seal member 632 is comprised of an internal seal flange portion 632a adjacent to an internal seal inlet 632e and an internal seal sheath portion 632b that extends from the internal seal flange portion 632a. The internal seal sheath portion 632b is further comprised of an internal seal interior surface 632c and an internal seal exterior surface 632d, which are bounded by the internal seal inlet 632e and an internal seal outlet 632f. The internal seal sheath portion 632b also has an internal seal slit 632g that runs from the interior seal outlet 632f along the internal seal sheath portion 632b a portion of the way toward the interior seal inlet 632e. The portions 632bi of the internal seal sheath portion 632b adjacent to the internal seal slit 632g are generally tapered so that the thickness of the internal seal sheath portion 632b is gradually reduced to zero thickness at the internal seal slit 632g, as is best illustrated in FIG. 12B. In this embodiment of the device 610, as illustrated in FIG. 13A and FIG. 13B, the external seal member 633 is comprised of an external seal flange portion 633a adjacent to an internal seal inlet 633e and an external seal sheath portion 633b extending from the external seal flange portion 633a. The external seal sheath portion 633b is further comprised of an external seal interior surface 633c and an external seal exterior surface 633d, which are bounded by the external seal inlet 633e and an external seal outlet 633f. The external seal sheath portion 633b also has an external seal slit 633g that runs from the external seal outlet 633f along the external seal sheath portion 633b a portion of the way toward the external seal inlet 633e. The portions 633bi of the external seal sheath portion 633b adjacent to the external seal slit 633g are generally tapered so that the thickness of the external seal sheath portion 633b is gradually reduced to zero thickness at the external seal slit 633g, as is best illustrated in FIG. 13A.

In operation of the device 610, the internal seal member 632 is positioned within the external seal member 633, as is best illustrated in FIG. 11 and FIG. 17B, so that the internal seal exterior surface 632d faces and may be adjacent to the external seal interior surface 633c. The internal seal flange portion 632a is also positioned adjacent to the external seal flange portion 633a and the two are operatively connected by the seal connecting means. Preferably, the seal connecting means connect the internal seal flange portion 632a and the external seal flange portion 633a, as portions of the internal seal member 632 adjacent to the internal seal inlet 632e and of the external seal member 633 adjacent to the external seal inlet 633e, respectively, in a manner that forms a fluid-tight seal between them. This fluid-tight seal (and the seal connecting means generally) may be formed by compression of the internal seal flange portion 632a against the external seal flange portion 633a or by use of other suitable means, such as adhesive, adhesive tape, glue, epoxy, welding, fusing, clasps, clamps, fasteners or other suitable attachment means or a combination of such means, in each case as applied to all or a portion of the internal seal flange portion 632a or the external seal flange portion 633a or both. In addition, the internal seal slit 632g is preferably positioned so that it is on approximately the opposite side of the duct sealing means from the external seal slit 633g, as is best illustrated in FIG. 11. Thus, as the duct (pipe 611) is inserted into the internal seal member 632 and the external seal member 633, the internal sheath member 632b and the external sheath member 633b change shape to conform to the shape of the exterior surface of the duct (pipe 611) (and any size adjusting means, such as wrap member 640, positioned thereon) at the end of the duct (pipe 611) so that they fit tightly against the exterior surface of the duct (pipe 611) (and any size adjusting means, such as wrap member 640, positioned thereon). In order to accommodate a larger size of duct (pipe 611), the internal seal sheath portion 632b and the external seal sheath portion 633b may also expand radially in a manner that causes the internal seal exterior surface 632d to slide circumferentially along the external seal interior surface 633c. As this expansion occurs, the internal seal slit 632g and the external seal slit 633g may also increase in size. Because the internal seal slit 632g and the external seal slit 633g are on approximately opposite sides, the seal slits 632g, 633g do not overlap as they widen, so that portions of the internal seal sheath portion 632b and the external seal sheath portion 633c are positioned adjacent to the duct (pipe 611) around the duct's (pipe 611) entire circumference. This preferably forms a fluid-tight seal between the exterior surface of the duct (pipes 611) (and any size adjusting means, such as wrap member 640, positioned thereon) and portions of the internal seal member 632 and the external seal member 633, creating the fluid-tight chamber 660, as illustrated and described in more detail elsewhere herein in connection with FIG. 17B.

It is to be noted that the duct sealing means (internal seal member 632 or external seal member 633 or both in the illustrated embodiment) may have a different configuration in other embodiments. For example, as illustrated in FIG. 12C, the internal seal member 632′ may not have a seal slit. Similarly, the external seal member 633 illustrated in FIG. 13A and FIG. 13B may not have a seal slit, in which case it would have an appearance similar to that of the internal seal member 632′ illustrated in FIG. 12C. Alternatively, both the internal seal member 632 and the external seal member 633 may not have a seal slit. In other embodiments, either or both seal slits 632g, 633g may have a different shape. For example, either or both of the seal slits 632g, 633g may be longer or shorter or may have a curved shape. As yet another example, the portion of the internal seal sheath portion 632b or the external seal sheath portion 633b or both adjacent to the seal slits 632g, 633g, respectively, may not be tapered. As still another example, the placement of the seal slits 632g, 633g relative to one another may be different (i.e., they may not be placed on opposite sides). Further, there may be more than one seal slit 632g, 633g in either or both of the internal seal member 632 and the external seal member 633, respectively. Further still, although it is preferable that the internal seal sheath portion 632b and the external seal sheath portion 633b are not attached to one another so that they can move relative to one another, in some embodiments they may be attached at one or more portions thereof. In yet other embodiments, the internal seal sheath portion 632b and the external seal sheath portion 633b may not be positioned adjacent to one another over their entire facing surfaces 632d, 633c. In yet other embodiments, the internal seal member 632 and the external seal member 633 may be fabricated together as a single component, in which case they may together have the appearance of the internal seal member 632′ illustrated in FIG. 12C.

In the embodiment illustrated in FIG. 10B through FIG. 13B (but excluding FIG. 12C), and FIG. 17B, the internal seal sheath portion 632b and the external seal sheath portion 633b, as duct sealing means, are both shaped approximately as a hollow hyperboloid with an approximately tubular (a hollow cylinder) portion extending longitudinally away from the narrower end of the hyperboloid portion. The internal seal inlet 632e and the external seal inlet 633e are positioned approximately within the open end 621a of the case body 621 so that the internal seal inlet 632e and the external seal inlet 633e generally coexist with the opening bounded by the case body open end 621a. The internal seal member 632 and the external seal member 633 extend from the case body open end 621a into the interior space 620a of the casing member 620. In this embodiment, the internal seal flange portion 632a and the external seal flange portion 633a have approximately the same shape as the cross-sectional shape of the case body 621 adjacent to its open end 621a. Thus, the internal seal flange portion 632a and the external seal flange portion 633a are approximately annular in shape because the case body 621 is tubular (hollow cylinder) in shape. In other embodiments, the internal seal member 632 and the external seal member 633 may have a different shape where necessary or desirable to conform to the cross-sectional shape of the case body 621. For example, if the case body 621 has a square cross-section, the internal seal flange portion 632a and the external seal flange portion 633a may also have a generally square shape of a size necessary to provide an operatively fluid-tight seal with the case body 621, as described in more detail herein. Alternatively, the hyperboloid portion of the internal seal sheath portion 632b and the external seal sheath portion 633b may be approximately conically shaped. Generally, the internal seal flange portion 632a and the external seal flange portion 633a are adapted to be sealed to the casing member 620, while also providing a flexible, operatively fluid-impermeable barrier that extends from the case body 621 to the internal seal outlet 632f and the external seal outlet 633f, which must be small enough to accommodate the smallest size of duct (pipe 611) that may be connected to the device 610. The internal seal member 632 and the external seal member 633 are shaped so that the duct (pipe 611) may be inserted into the internal seal member 632 and the external seal member 633 without excessively inhibiting the movement of the duct (pipe 611) into or tearing the internal seal member 632 or the external seal member 633. To accomplish this function, the internal seal sheath portion 632b and the external seal sheath portion 633b may be shaped as one or more linear or arcuate segments or a combination of such segments when viewed in cross-section perpendicular to the longitudinal axis of the internal seal member 632 and the external seal member 633 (the axis generally defined by a line passing through the centers of the seal inlets 632e, 633e and the seal outlets 632f, 633f). The cross-sectional dimension of the internal seal sheath portion 632b and the external seal sheath portion 633b generally decreases with distance along at least a portion of the longitudinal axis from the inlets 632e, 633e to the seal outlets 632f, 633f. Thus, the internal seal sheath portion 632b and the external seal sheath portion 633b preferably have a smooth arcuate shape adjacent to the internal seal flange portion 632a and the external seal flange portion 633a, respectively, when viewed perpendicular to the longitudinal axis of the internal seal member 32 and the external seal member 633, respectively.

In the embodiment of the device 610 illustrated in FIG. 10B through FIG. 13B (but excluding FIG. 12C), and FIG. 17B, the distal end portions of the internal seal sheath portion 632b and the external seal sheath portion 633b are approximately tubular in shape. This shape, which is approximately the same as the exterior surface of the duct (pipe 611) at its end, may allow for a fluid-tight seal around the entire perimeter of the duct (pipe 611) at its end (and any size adjusting means, such as wrap member 640, positioned thereon). In other embodiments, this portion of the internal seal sheath portion 632b and the external seal sheath portion 633b may have different shapes. For example, portions of the internal seal sheath portion 632b and the external seal sheath portion 633b may have a cross-sectional shape that is approximately elliptical, triangular, square, rectangular, another polygonal shape, or another shape or combination of such shapes where such shape may better accommodate the size and shape of the duct (pipe 611). As described in more detail below, the internal seal sheath portion 632b and the external seal sheath portion 633b are preferably constructed of an elastic material so that they change shape, and stretch as necessary, to conform to the exterior surface of the duct (pipe 611) adjacent to the end thereof, forming a fluid-tight seal between the internal seal member 632 and the external seal member 633 and the duct (pipe 611) (and any size adjusting means, such as wrap member 640, positioned thereon). To enhance this seal, the cross-sectional area of the internal seal sheath portion 632b and the external seal sheath portion 633b are also preferably the same as or slightly smaller than the cross-sectional area of the smallest duct (pipe 611) that may be connected to the compression connector 615. The internal seal sheath portion 632b and the external seal sheath portion 633b preferably extend a distance along the exterior surface of the duct (pipe 611) adequate to produce a fluid-tight seal between the internal seal member 632 and the external seal member 633 and the duct (pipe 611) (and any size adjusting means, such as wrap member 640, positioned thereon) adjacent to the end thereof. It is to be noted, however, that in some embodiments it is not necessary that the contact between the internal seal member 632 and the external seal member 633 and the duct (pipe 611) (and any size adjusting means, such as wrap member 640, positioned thereon) alone provide a fluid-tight seal. Supplemental duct sealing means, as described in more detail below, may be used to provide or enhance this seal.

The duct sealing means (internal seal member 632 and external seal member 633) are generally constructed of materials that permit them to expand to conform to the exterior surface of the largest size of duct (adjacent to the end of pipe 611) that may be connected to the device 610, while still maintaining the structural integrity of the internal seal member 632 and the external seal member 633 during operation of the compression connector 615. In addition, the materials are preferably compatible with the type of fluid anticipated in the interior space 611b of the duct (pipe 611) and thus, anticipated in the chamber 660. For example, the internal seal member 632 and the external seal member 633 may each be comprised of any suitable elastic material, such as rubber, synthetic rubber (including NEOPRENE), elastomers or other elastic polymers, or combinations of such materials, along with a combination that may including cloth, fabric or other flexible or semi-flexible materials. It is to be noted, however, that the internal seal member 632 and the external seal member 633 need not be constructed entirely of flexible or elastic materials. For example, the internal seal flange portion 632a and the external seal flange portion 633a, or a portion of the internal seal sheath portion 632b and the external seal sheath portion 633b adjacent to the internal seal flange portion 632a and the external seal flange portion 633a, respectively, or any combination thereof, may be comprised of a rigid or semi-rigid material, such as wood, ceramic, metal, fiberglass, carbon-based or other composites, rigid or semi-rigid polymers (such as polyvinyl chloride and polycarbonate), or other rigid or semi-rigid materials or a combination of such materials. This may assist in facilitating a fluid-tight seal between the internal seal flange portion 632a and the external seal flange portion 633a and the case body 621 in some embodiments. In addition, the internal seal member 632 or the external seal member 633 or both may be comprised of materials having varying degrees of elasticity. For example, portions of the internal seal sheath portion 632b and the external seal sheath portion 633b adjacent to the internal seal flange portion 632a and the external seal flange portion 633a, respectively, may be comprised of a more rigid material than the portions adjacent to the internal seal outlet 632f and the external seal outlet 633f, respectively. Alternatively, the elasticity of various portions of the internal seal member 632 or the external seal member 633 or both may be varied by varying the thickness of the material comprising the internal seal member 632 or the external seal member 633, respectively, used with such portions. For example, the internal seal flange portion 632a and the external seal flange portion 633a, or a portion of the internal seal sheath portion 632b and the external seal sheath portion 633b adjacent to the internal seal flange portion 632a and the external seal flange portion 633a, respectively, or any combination thereof, may be constructed of thicker material than the remaining portions of the internal seal member 632 or the external seal member 633, respectively, so that the remaining portions are generally more elastic than the other portions. Further, the internal seal member 632 and the external seal member 633, as well as various portions thereof, may have different degrees of elasticity. By varying the elasticity of the internal seal member 632 and the external seal member 633, as well as various portions thereof, the ability of the internal seal member 632 or the external seal member 633 to form a fluid-tight seal with the duct (pipe 611) (and any size adjusting means, such as wrap member 640, positioned thereon) and to grip the duct (pipe 611) to operatively hold it in place may be optimized.

The thickness of the material comprising the internal seal member 632 and the external 10 seal member 633 must be such that it allows for the internal seal member 632 and the external seal member 633, respectively, to change shape to conform to the exterior surface of the largest size of duct (adjacent to the end of pipe 611) that may be connected to the compression connector 615, while still maintaining the structural integrity of the internal seal member 632 and the external seal member 633 during operation of the compression connector 615. The internal seal member 632 and the external seal member 633 may be constructed using any suitable means. For example, internal seal members 632 and external seal members 633 constructed entirely of synthetic rubber may be cast in a mold. As another example, an internal seal member 632 and an external seal member 633 comprised of one or more materials may have various components assembled utilizing adhesives, welding, fusing or any other suitable means. Further, the seal connecting means are utilized in connecting the internal seal member 632 and the external seal member 633, as described in more detail above. Preferably, for compression connectors 615 utilizing the internal support structure 631 and the external support structure 634 of the illustrated embodiment and designed for use with tubular ducts (pipe 611) having a nominal diameter in the range of ½″ to ¾″ carrying potable water for domestic use, the internal seal member 632 and the external seal member 633 have the configuration illustrated in FIG. 11 through FIG. 12B and are constructed entirely of NEOPRENE having a thickness in the range of 1/16 inch to ⅛ inch. It is also to be noted that in various embodiments of the present invention, the duct sealing means may have any structure, characteristics, features, functions, and operation disclosed for the sealing member and its ancillary members in U.S. patent application Ser. No. 11/879,346, the full disclosure of which is incorporated herein by this reference.

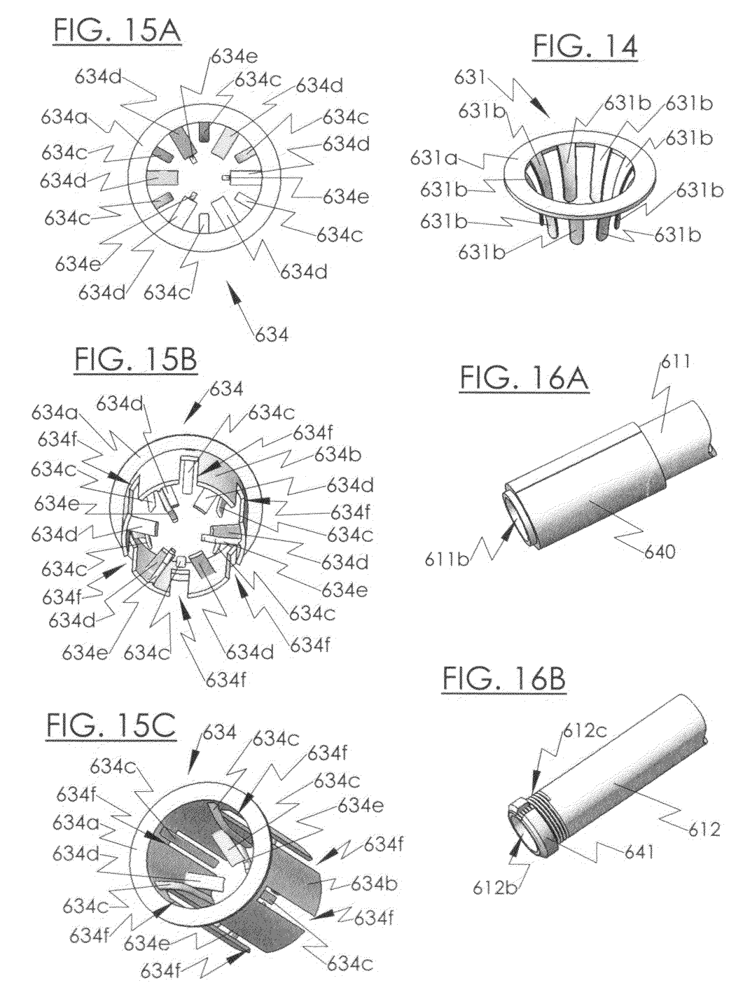

In the embodiment of the compression connector 615 illustrated in FIG. 10A through FIG. 10C and FIG. 14 through FIG. 15C, and as best illustrated in FIG. 14 through FIG. 15C, the seal support means are generally comprised of an internal support structure 31 and an external support structure 34. As is best illustrated in FIG. 11 and FIG. 14, the internal support structure 631 is comprised of an internal support flange member 631a and a plurality of internal support tab members 631b that extend from the internal support flange member 631a into the vicinity of the interior surface 632c of the internal seal sheath portion 632b (see also FIG. 12A and FIG. 12B). By “into the vicinity of,” it is meant that the internal support tab members 631b are positioned within (or possibly above) the volume inside the internal seal member 632 prior to the insertion of the duct (pipe 611), so that the internal support tab members 631b are able to perform their intended function of guiding the duct (pipe 611) into the internal seal member 632 and external seal member 633 as the duct (pipe 611) is being inserted into the device 610. The internal support flange member 631a is preferably positioned approximately adjacent to the internal seal flange portion 632a of the internal seal member 632. By “approximately adjacent,” it is meant that the internal support flange member 631a is generally intended to be positioned adjacent to the internal seal flange portion 632a, but that other items, such as washers, o-rings or other members, may be positioned between the internal support flange member 631a and the internal seal flange portion 632a in some embodiments. The internal support flange member 631a and the internal seal flange portion 632a are preferably positioned approximately in the open end 621a of the case base 621 along with other components comprising the variable connecting member 630, as described in more detail and illustrated in connection with FIG. 10B and FIG. 17B. The internal support flange member 631a is also preferably attached (but need not be attached in every embodiment) to the internal seal flange portion 632a using any suitable means, such as adhesive, adhesive tape, glue or epoxy, welding, fusing, clasps, clamps, or other suitable attachment means or a combination of such means.

The internal support flange member 631a may have a different size and shape in other embodiments of the present invention. For example, where the case base 621 has a square cross-section, it may be necessary or desirable for the internal support flange member 631a to be square as well to facilitate its connection to the case base 621. In the illustrated embodiment, each of the internal support tab members 631b generally extends from the internal support flange member 631a along the interior surface 632c of the internal seal member 632 to a point just beyond the location on the internal seal sheath portion 632b where the internal seal sheath portion 632b becomes tubular in shape. In other embodiments, the internal support tab members 631b may extend a lesser or greater distance along the internal seal sheath portion 632b. In addition, the internal support tab members 631b are preferably positioned adjacent to the interior surface 632c of the internal seal member 632, but need not be positioned adjacent to such surface 632c in every embodiment. Further, there may be more or fewer internal support tab members 631b, and the internal support tab members 631b may have a different shape than that illustrated in FIG. 10B and FIG. 14 in other embodiments. The internal support tab members 631b may also each have different lengths. Although the internal support flange member 631a may have the same thickness as the internal support tab members 631b in some embodiments, in other embodiments the internal support flange member 631a may have a thickness different than one or more of the internal support tab members 631b. In addition, the thickness of the internal support tab members 631b may vary over their length. For example, as illustrated in FIG. 11, FIG. 14, and FIG. 17B, the internal support tab members 631b may be thicker adjacent to the internal support flange member 631a than they are at their distal ends. The internal support structure 631 may be comprised of any suitable rigid or semi-rigid material, such as metal (such as steel, steel alloys, aluminum, copper, brass, or other metals or metal alloys), polymers (such as PVC, polyethylene, polypropylene, ABS, NYLON and NYLON/glass combinations, and other polymers), wood, fiberglass, carbon-based or other composites, or other materials or a combination of such materials. Although the internal support flange member 631a and the internal support tab members 631b are preferably comprised of the same material, they may be comprised of different materials in various embodiments. The internal support structure 631 may be fabricated using any suitable means, such as injection molding for an internal support structure 631 comprised of polymers and metal injection molding for an internal support structure 631 comprised of metal. More preferably, the internal support structure 631 has the geometry illustrated in FIG. 11 and FIG. 14, and is comprised of stainless steel or a NYLON/glass combination, which may be fabricated using metal injection molding or injection molding, respectively. It is to be noted that there may be more than one internal support structure 631 utilized in some embodiments of the present invention.

In the illustrated embodiment of the compression connector 615, as best illustrated in FIG. 10B, FIG. 11, and FIG. 15A through FIG. 15C, the external support structure 634 is comprised of an external support flange member 634a, an external support shell member 634b, a plurality of seal support members 634c, a plurality of radial support members 634d, and a plurality of end support members 634e. The seal support members 634c, the radial support members 634d, and the end support members 634e are sometimes referred to collectively as “external supporting members” herein. In this embodiment, the external support flange member 634a is an annular-shaped rigid member. Also in this embodiment, the external support flange member 634a is rigidly connected to the casing member 620, being positioned between the washer 635 and the external seal flange portion 633a. Preferably, the external support flange member 634a is attached to the washer 635 and the external seal flange portion 633a, using any suitable means, such as an adhesive, adhesive tape, glue, epoxy, welding, fusing, clamp, clasp or other fastening means or a combination of such means. The external support flange member 634a may have a different size and shape in other embodiments of the present invention. For example, where the case base 621 has a square cross-section, it may be necessary or desirable for the external support flange member 634a to be square to facilitate its connection to the case base 621. The external support flange member 634a may be constructed of any suitable material, as long as the external support flange member 634a is capable of performing its function (in this embodiment) as the primary point of connection of the external support structure 634 to the casing member 620. Preferably, the external support flange member 634a is comprised of a rigid or semi-rigid material, such as metal (e.g., spring steel, copper, brass, aluminum, another steel, or steel or metal alloy), wood, ceramic, fiberglass, carbon-based or other composites, rigid or semi-rigid polymers (such as PVC, NYLON or NYLON/glass combination, and polycarbonate), or other rigid or semi-rigid materials or a combination of such materials. In addition, it is preferred that the material comprising the external support flange member 634a be compatible with the fluid carried by the duct (pipe 611).

As illustrated in FIG. 15A through FIG. 15C, and FIG. 17B, the external support shell member 634b extends from the interior edge of the external support flange member 634a a distance adequate to operationally enclose the internal seal member 632 and the external seal member 633. Preferably, the external support shell member 634b is positioned approximately adjacent to the interior surface of the case base 621 along its entire length, but it need not be so positioned in every embodiment of the present invention. In addition, the external support shell member 634b is preferably fabricated along with the external support flange member 634a as a single component. Alternatively, the external support shell member 634b may be connected to the external support flange member 634a by a suitable joining means, such as an adhesive, adhesive tape, glue, epoxy, welding, fusing, brazing, or other joining means or a combination of such means. The external support shell member 634b may be constructed of any suitable material, as long as the external support shell member 634b is capable of performing its intended function of providing structural support to the variable connecting member 630 during operation of the device 610, as described in more detail below. Preferably, the external support shell member 634b is comprised of a rigid or semi-rigid material, such as metal (e.g., spring steel, copper, brass, aluminum, another steel, or steel or metal alloys), wood, ceramic, fiberglass, carbon-based or other composites, rigid or semi-rigid polymers (such as PVC, NYLON or NYLON/glass combination, or polycarbonate), or other rigid or semi-rigid materials or a combination of such materials. In addition, it is preferred that the material comprising the external support shell member 634b be compatible with the fluid carried by the duct (pipe 611). Although the illustrated external support shell member 634b is tubular in shape, it may have a different shape in other embodiments. For example, where the case base 621 has a square cross-section, it may be necessary or desirable for the external support shell member 634b to be square to facilitate its operation in conjunction with the case base 621, as such operation is generally illustrated and described below in connection with FIG. 17B. The external support shell member 634b may also have one or more shell slits 634f that extend from the distal end of the external support shell member 634b approximately longitudinally a predetermined distance toward the external support flange member 634a. The shell slits 634f permit the external support shell member 634b to be deflected radially outward in order to be able to remove the duct (pipe 611) from the compression connector 615 when it is desirable to do so. In the illustrated embodiment, there are six shell slits 634f, which is the preferred number. In other embodiments, however, there may be more or fewer shell slits 634f or no shell slits 634f at all. In addition, although the shell slits 634f preferably have the shape illustrated in FIG. 11 and FIG. 15A through FIG. 15C, each of the shell slits 634f may also have a different shape in other embodiments. For example, the shell slits 634f may have various widths, lengths, and linear and arcuate segments or a combination thereof.

In the embodiment of the compression connector 615 illustrated in FIG. 11 and FIG. 15A through FIG. 15C, the plurality of seal support members 634c extend from the interior surface of the external support shell member 634b into the interior space within the external support shell member 634b. Alternatively, the seal support members 634c may extend from the interior edge of the external support flange member 634a into the interior space within the external support shell member 634b. Preferably, the seal support members 634c conform approximately to a portion of the contour of the exterior surface 633d of the external seal sheath portion 633b and generally extend along the exterior surface 633d of the external seal sheath portion 633b to the distal end thereof. In other embodiments, seal support members 634c may extend along a portion of the exterior surface 633d of the external seal sheath portion 633b to a point short of the distal end thereof or a distance beyond the distal end thereof. The seal support members 634c are preferably constructed of a resilient material that may be deformed radially outward from the longitudinal center of the external support shell member 634b while the duct (pipe 611) is inserted into the compression connector 615, but which apply a force radially inward against the external seal sheath portion 633b and the internal seal sheath portion 633b, so that the duct (pipe 611) tends to be held operatively in place radially with respect to the external support shell member 634b. In addition, as portions of the internal seal sheath portion 632b and the external seal sheath portion 633b slide along one another circumferentially as a duct (pipe 611) of larger size is inserted into the compression connector 615, the seal support members 634c also tend to hold the internal seal sheath portion 632b and the external seal sheath portion 633b in place relative to one another so that they are not unduly deflected radially outward. The seal support members 634c may be comprised of any suitable resilient material, as long as the seal support members 634c are together capable of performing their intended function of deforming when the duct (pipe 611) is inserted into the compression connector 615 and operatively holding the internal seal sheath portion 632b, the external sheath seal portion 633b, and the duct (pipe 611) in operatively in place radially with respect to one another, the external support structure 634, and the casing member 620 while the duct (pipe 611) is so inserted. Preferably, the seal support members 634c are comprised of a resilient rigid or semi-rigid material, such as metal (e.g., spring steel, copper, brass, aluminum, another steel, or steel or metal alloys), wood, fiberglass, carbon-based or other composites, rigid or semi-rigid polymers (such as PVC, NYLON or NYLON/glass combination, and polycarbonate), or other resilient rigid or semi-rigid materials or a combination of such materials. In addition, it is preferred that the material comprising the seal support members 634c be compatible with the fluid carried by the duct (pipe 611). More preferred, the seal support members 634c are comprised of a NYLON/glass combination or stainless steel covered by an appropriate protective coating where necessary to protect the stainless steel against the type of fluid expected to be carried by the duct (pipe 611). In this embodiment, one end of each of the seal support members 634c is rigidly connected to the external support shell member 634b. This connection is preferably accomplished by a suitable joining means, such as an adhesive, adhesive tape, glue, epoxy, welding, fusing, brazing, or other joining means or a combination of such means. Alternatively, and preferably, one or more of the seal support members 634c may be fabricated along with the external support shell member 634b as a single component. In other embodiments, there may be fewer or more seal support members 34c. Preferably, there are six seal support members 634c. In addition, it is to be noted that the seal support members 634c may have a shape and size different from that illustrated in FIG. 11 and FIG. 15A through FIG. 15C in other embodiments of the present invention. For example, one or more of the seal support members 634c may have one or more segments that are linear or arcuate in shape or a combination of such shapes when viewed from almost any perspective.

In the embodiment of the compression connector 615 illustrated in FIG. 11 and FIG. 15A through FIG. 15C, each of the plurality of radial support members 634d extends from the interior surface of the external support shell member 634b into the interior space within the external support shell member 634b. Preferably, the radial support members 634d generally extend into the interior space of the external support shell member 634b a distance great enough so that they will abut against the exterior surface of the smallest size of duct (pipe 611) that may be connected to the compression connector 615 when the duct (pipe 611) is inserted into the compression connector 615. The radial support members 634d are preferably constructed of a resilient material that may be deformed radially outward from the longitudinal axis of the external support shell member 634b when the duct (pipe 611) is inserted into the compression connector 615, but which apply a force radially inward against the duct (pipe 611) tending to operatively hold it operatively in place radially with respect to the external support shell member 634b and the case body 621. The radial support members 634d may be comprised of any suitable resilient material, as long as the radial support members 634d are together capable of performing their intended function of deforming when the duct (pipe 611) is inserted into the compression connector 615 and holding the duct (pipe 611) operatively in place radially with respect to the external support shell member 634b and the casing member 620 while the duct (pipe 611) is so inserted. Such resilient material may include metal (e.g., spring steel, copper, brass, aluminum, another steel, or steel or metal alloys), wood, fiberglass, carbon-based or other composites, rigid or semi-rigid polymers (such as PVC, NYLON and NYLON/glass combinations, and polycarbonate), or other resilient materials or a combination of such materials. In addition, it is preferred that the material comprising the radial support members 634d be compatible with the fluid carried by the duct (pipe 611). More preferred, the radial support members 634d are comprised of NYLON/glass combination or stainless steel covered by an appropriate protective coating where necessary to protect the stainless steel against the type of fluid expected to be carried by the duct (pipe 611). In this embodiment, one end of each of the radial support members 634d is rigidly connected to the interior surface of the external support shell member 634b. This connection is preferably accomplished by a suitable joining means, such as an adhesive, adhesive tape, glue, epoxy, welding, fusing, brazing, or other joining means or a combination of such means. Alternatively, and preferably, one or more of the radial support members 634d may be fabricated along with the external support shell member 634b as a single component. It is to be noted that in other embodiments one or more of the radial support members 634d may be connected directly to (or may be a part of) the external support flange member 634a or another external supporting member 634c, 634e, as described in more detail below. In the illustrated embodiment, there are six radial support members 634d, which is the preferred number. In other embodiments, there may be fewer or more radial support members 634d. In addition, it is to be noted that the radial support members 634d may have a shape and size different from that illustrated in FIG. 11 and FIG. 15A through FIG. 15C in other embodiments of the present invention. For example, one or more of the radial support members 634d may have one or more segments that are linear or arcuate in shape or a combination of such shapes when viewed from almost any perspective. As best illustrated in FIG. 15A through FIG. 15C and FIG. 17B, the distal end of each of the radial support members 654d (of variable connecting member 650) may also preferably have a slightly arcuate shape so that the distal end may engage any threads 612c present on the end of the duct (pipe 612), which may provide additional assistance in operatively holding the duct (pipe 612) in place relative to the compression connector 615 against any thrust loads.

In the embodiment of the compression connector 615 illustrated in FIG. 11 and FIG. 15A through FIG. 15C, the plurality of duct end support members 634e extend from the interior surface of the external support shell member 634b into the interior space within the external support shell member 634b. The duct end support members 634e extend into the interior space of the case body 621a distance great enough so that they will abut against the end of the smallest size of duct (pipe 611) that may be connected to the compression connector 615 when the duct (pipe 611) is inserted into the compression connector 615. In addition, the duct end support members 634e are preferably shaped to minimize the disruption of fluid flowing between the duct (pipe 611) and the casing interior space 620a. Thus, the duct end support members 634e act as a stop, preventing the duct (pipe 611) from being inserted into the casing member 620 beyond the duct end support members 634e, while still allowing for relatively unrestricted fluid flow through the device 610. In this embodiment, one end of each of the duct end support members 634e is rigidly connected to the external support shell member 634b at the distal end thereof. This connection is preferably accomplished by a suitable joining means, such as an adhesive, adhesive tape, glue, epoxy, welding, fusing, brazing, or other joining means or a combination of such means. Alternatively, and preferably, one or more of the duct end support members 634e may be fabricated along with the external support shell member 634b as a single component. In other embodiments, one or more of the duct end support members 634e may extend from the external support flange member 634a, another of the external supporting members 634c, 634d, or from a location on the external support shell member 634b other than the distal end of the external support shell member 634b. The duct end support members 634e may be constructed of any suitable material, as long as the duct end support members 634e are together capable of performing their intended function of acting as a stop for the duct (pipe 611) while minimizing disruption of fluid flow through the device 610. Preferably, the duct end support members 634e are comprised of a rigid or semi-rigid material, such as metal (e.g., spring steel, copper, brass, aluminum, another steel, or steel or metal alloys), wood, ceramic, fiberglass, carbon-based or other composites, rigid or semi-rigid polymers (such as PVC, NYLON and NYLON/glass combinations, and polycarbonate), or other rigid or semi-rigid materials or a combination of such materials. In addition, it is preferred that the material comprising the duct end support members 634e be compatible with the fluid carried by the duct (pipe 611). In the illustrated embodiment, there are three duct end support members 634e, which is the preferred number. In other embodiments, there may be fewer or more duct end support members 634e. In addition, it is to be noted that the duct end support members 634e may have a shape and size different from that illustrated in FIG. 11 and FIG. 15A through FIG. 15C in other embodiments of the present invention. For example, one or more of the duct end support members 634e may have one or more segments that are linear or arcuate in shape or a combination of such shapes when viewed from almost any perspective. Preferably, as illustrated in FIG. 11 and FIG. 15A through FIG. 15C, the duct end support members 634e are angled toward the end of the duct (pipe 611) at their distal ends so that they act as an additional means of centering the duct (pipe 611) radially within the casing member 620. In addition, it is preferred that the duct end support members 634e have a cross-section shaped approximately as an ellipse, with the major axis aligned longitudinally (with the direction of fluid flow through the device 610) to provide a more aerodynamic or hydrodynamic surface in order to minimize flow disruption. Further, although it is preferred that the duct end support members 634e do not extend across the entire interior dimension of the external support shell member 634b in order to minimize fluid flow disruption, as illustrated in FIG. 11 and FIG. 15A through FIG. 15C, one or more of the duct end support members 634e may extend across the entire interior dimension of the external support shell member 634b in other embodiments of the present invention.

It is to be noted that there are numerous potential variations in the structure, features, characteristics and operation of the seal support means. While the seal support means (internal support structure 631 and external support structure 634 in the illustrated embodiments) are described in conjunction with the preferred aspects, versions and embodiments, it is to be noted that the aspects, versions and embodiments are not intended to limit the invention to those aspects, versions and embodiments. On the contrary, the seal support means are specifically intended to cover alternatives, modifications and equivalents, which may be included within the spirit and scope of the invention as defined by the appended claims. For example, the seal support means of the present invention may include any internal support means or support assembly or both disclosed in U.S. Nonprovisional patent application Ser. Nos. 11/879,346, and any of the seal support means (including exterior support substructures) disclosed in U.S. Provisional Patent Application No 60/______, entitled DEVICE FOR CONNECTING TO DUCTS OF VARIOUS SIZES AND SHAPES, filed on Jan. 25, 2008. The entire disclosures of such patent applications are incorporated herein by this reference.

Referring again to FIG. 11 through FIG. 15C (excluding FIG. 12C), and FIG. 17B, as an example, the variable member connecting means are used to connect the variable connecting members 630, 650 to the casing member 620. Preferably, and referring to variable connecting member 630 as an example, this connection also provides a fluid-tight seal between the variable connecting member 630 and the casing member 620. In the illustrated embodiment, the portion of the case cap 622 adjacent to the duct opening 622a is pressed against the internal support flange member 631a, the internal seal flange portion 632a, the external seal flange portion 633a, the external support flange member 634a, and the washer 635 as the case cap 622 is screwed down onto the case body 621. This compression acts as the variable member connecting means to connect the variable connecting member 630 to the casing member 620, and also provides a fluid-tight seal between the variable connecting member 630 and the casing member 620, so that a fluid-tight chamber 660 is formed. In the illustrated embodiment, the chamber 660 is bounded by the exterior surfaces 632d, 633d of the internal seal member 632 and the external seal member 633, respectively, the equivalent surfaces of the internal seal member 652 and the external seal member 653 of the variable connecting member 650, the internal surfaces of the case body 621, and the internal surfaces of the ducts (pipes 611, 612). In the illustrated embodiment, the variable member connecting means are also comprised of the washer 635 to assist in providing a fluid-tight seal. It is to be noted, however, that the variable member connecting means need not provide a fluid-tight seal in every embodiment of the present invention. In other embodiments, the variable member connecting means may comprise any suitable means for providing a connection between one or more portions of the variable connecting member 630 and one or more portions of the casing member 620, such as gaskets, o-rings, sealing compounds, adhesive, adhesive tape, glue, epoxy, welding fusing, compression of the joining portions of the variable connecting member 630 and the casing member 620, fabrication of all or a portion of the variable connecting member 630 as a part of the casing member 620, or any other connecting or sealing means or a combination of such means. Where washers 635, gaskets or o-rings are utilized, they may be constructed of any suitable materials, such as rubber, synthetic rubber, or other polymers. The preferred variable member connecting means are comprised of the variable connecting member 630 being held in place between the case cap 622 and the case body 621 in the manner illustrated in FIG. 11 through FIG. 15C (excluding FIG. 12C), and FIG. 17B. In other embodiments, which are the preferred embodiments, two or more of the components comprising the variable connecting members 630, 650 may also be joined together using any suitable means. Referring to variable connecting member 630 as an example, portions of the internal seal member 632 and portions of the external seal member 633 may be connected by seal connecting means, which are described in more detail above and illustrated in connection with FIG. 12A through FIG. 12C. In addition, the internal support flange member 631a, the internal seal flange portion 632a, the external seal flange portion 633a, the external support flange member 634a, and the washer 635 may each be attached to the adjoining member by an adhesive, adhesive tape, glue or epoxy or a combination of the same. Other possible means of attachment may include welding, fusing, clasps, clamps, or other suitable attachment means or a combination of such means.

As described above with respect to the embodiment of the compression connector 615 illustrated in FIG. 11 through FIG. 15C (excluding FIG. 12C), and FIG. 17B, the preferred embodiment of the variable connecting means (variable connecting member 630, 650) is dependent upon a number of factors that bear upon each of the members comprising the variable connecting means, as described in more detail above in connection with the description of each such member. The more preferred embodiment of variable connecting member 630, 650, using variable connecting member 630 as an example, used for connecting pipes carrying potable water at room temperature includes an internal support structure 631 having the geometry illustrated in FIG. 14 and being constructed of a NYLON/glass combination, an internal seal member 632 and an external seal member 633 having the geometries illustrated in FIG. 12A, FIG. 12B, FIG. 13A, and FIG. 13B and being constructed entirely of NEOPRENE, an external support structure 634 having the geometry illustrated in FIG. 15A through FIG. 15C and being constructed of stainless steel, and a variable member connecting means comprised of a washer 635 constructed of NEOPRENE. It is to be noted, however, that in various embodiments of the invention one or more of the external supporting members 634c, 634d, 634e best illustrated in FIG. 15A through FIG. 15C that comprise the external support structure 634 may not be used, such as where the intended use of the compression connector 615 does not require such members. For example, various embodiments of the compression connector 615 may incorporate radial support members 634d, but not duct end support members 634e.

Operation of the device 610 in conjunction with various wrap means may be illustrated by reference to FIG. 16A through FIG. 17B. In this embodiment, the ducts 611, 612 to be connected to the compression connector 615 are illustrated in FIG. 16A and FIG. 16B. In the case of the smaller duct (pipe 612), the wrap means are comprised of a wrap member 641, which acts as thrust load restraint means. This duct (pipe 612) is connected to the variable connecting member 650, and serves to illustrate operation of the compression connector 615 as it is connected to a duct (pipe 612) of smaller diameter having threads 612c on its distal end. In the case of the larger duct (pipe 611), the wrap means are comprised of a wrap member 640, which acts as size adjusting means. This duct (pipe 611) is connected to the variable connecting member 630, and serves to illustrate operation of the compression connector 615 as it is connected to a duct (pipe 611) of larger diameter that does not have threads on its distal end. It is to be noted that any of the wrap means and wrap connecting means described above and illustrated in connection with FIG. 1 through FIG. 9 may be used in connection with any duct (pipes 611, 612) that may be properly connected to the compression connector 615. It is also to be noted that the operation of the variable connecting member 650 has substantially the same structure, features, characteristics, functions and operation as the variable connecting member 630 illustrated and described in more detail above and illustrated in FIG. 10A through FIG. 15C. The operation of the device 610 as part of a system in which the fluid is under pressure is as follows, but it is to be noted that the device 610 need not be operated as part of a system where the fluid is under pressure.

For operation with a smaller duct sizes (as is the case with pipe 612), the wrap member 641 may be connected to the exterior surface of the duct (pipe 612) using appropriate wrap connecting means. It is to be noted that a portion of this wrap member 641 is comprised of soft rubber or synthetic rubber so that it may be deformed enough to fill all or a portion of the space between the threads 612c of the duct (pipe 612). This type of deformation is preferred when the wrap member 641 is used with ducts (pipe 612) having threads 612c to increase the adhesion between the wrap member 641 and the duct (pipe 612) provided by the wrap connecting means. In addition, the wrap member 641 does not extend around the entire circumference of the duct (pipe 612) in this embodiment. The compression connector 615 is selected and the threaded 612c end of the duct (pipe 612) is inserted into (and received by) the duct opening 623a of the casing member 620, the internal support structure 651, the internal seal member 652, and the external seal member 653 of the variable connecting member 650. In this embodiment, the duct (pipe 612) has a generally cylindrical shape and an outside diameter within a predetermined range. For example, the pipe 612 in some embodiments may have an outside diameter within the range of 0.8 inches to 1.0 inches. In addition, the duct (pipe 612) may have a variety of different thread 612c types on its end, as described in more detail above and illustrated in connection with FIG. 1 through FIG. 9. Thus, the compression connector 615 is capable of connecting to a variety of different types and sizes of ducts (pipe 612). As the duct (pipe 612) is being inserted into (and received by) the compression connector 615, if the outside diameter of the duct (pipe 612) is the minimum acceptable diameter of the duct (pipes 612), the distal end of the duct (pipe 612) may travel down the longitudinal axis of the variable connecting member 650 with only minimal contact against the internal support tab members 651b and the internal seal member 652. The duct (pipe 612) is advanced into the compression connector 615 until a portion of the interior surface of the internal seal member 652 and a portion of the interior surface of the external seal member 653 have changed shape, and possibly expanded, to conform to and be positioned adjacent to the exterior surface of the duct (pipe 612). As the duct (pipe 612) is inserted into the internal seal member 652 and the external seal member 653, the exterior surface of the internal seal sheath portion 652b may slide circumferentially along the interior surface of the external seal sheath portion 653b, causing the internal seal slit (not illustrated) and the external seal slit (not illustrated) to widen. In the case of smaller duct (pipe 612) sizes, the pipe 612 is operatively held in place in the compression connector 615 primarily by the inward radial pressure of the inlet support tab members 651b, the seal support members 654c, and the radial support members 654d, and secondarily by the internal seal member 652 and the external seal member 653. In other embodiments, all or any combination of the duct sealing means or the seal support means (which are described in more detail above and illustrated in connection with FIG. 10A through FIG. 15C) may be used to hold the pipe 612 operatively in place in the compression connector 615. In embodiments of the compression connector 615 that comprise duct end support members 654e, the duct (pipe 612) may be inserted into the compression connector 615 until the duct (pipe 612) open end abuts against the duct end support members 654e.

For operation with larger duct sizes (as is the case with pipe 611), the wrap member 640 may be connected to the exterior surface of the duct (pipe 611) using appropriate wrap connecting means. The wrap member 640 in this embodiment acts as size adjusting means. In this case, the compression connector 615 is selected and the distal end of the duct (pipe 611) is inserted into (and received by) the variable connecting member 630 of the compression connector 615. As the duct (pipe 611) is inserted into the compression connector 615, the duct (pipe 611) (and the wrap member 640) first impacts the internal support tab members 631b of the internal support structure 631, causing the internal support tab members 631b to be deformed radially against the interior surface 632c of the internal seal member 632 and the interior surface 633c of the external seal member 633. As the duct (pipe 611) continues into the compression connector 615, the distal end of the duct (pipe 611) (and the wrap member 640) continues to force the internal support tab members 631b radially outward against the internal seal member 632 and the external seal member 633, forcing them to expand radially outward. As this happens, the exterior surface 632d of the internal seal sheath portion 632b slides circumferentially along the interior surface 633c of the external seal sheath portion 633b, causing the internal seal slit 632g and the external seal slit 633g to widen. This deformation also causes the exterior surface 632d of the internal seal member 632 and the exterior surface 633d of the external seal member 633 to be forced against the seal support members 634c, which causes the seal support members 634c to deform radially outward as well. As the internal seal member 632 and the external seal member 633 are forced against the seal support members 634c, the seal support members 634c tend to hold the internal seal member 632 and the external seal member 633 in place relative to one another so that the portions 632bi, 633bi adjacent to the internal seal slit 632g and the external seal slit 633g, respectively, are not deflected radially outward a detrimental amount. In addition, the internal support tab members 631b and the seal support members 634c hold the duct (pipe 611) radially centered in the compression connector 615 as the pipe 611 continues its travel into the compression connector 615. The internal support tab members 631b also prevent the duct (pipe 611) (and the wrap member 640) from binding or impinging against the interior surface 632c of the internal seal member 632 and the interior surface 633c of the external seal member 633 as the duct (pipe 611) is being inserted into the compression connector 615. As the duct (pipe 611) is advanced further into the compression connector 615, the duct (pipe 611) (and the wrap member 640) continues forcing the internal seal member 632 and the external seal member 633 to expand radially outward until a portion of the interior surface 632c of the internal seal member 632 and the interior surface 633c of the external seal member 633 have expanded to conform to and are positioned adjacent to the exterior surface of the duct (pipe 611), which is actually the exterior surface of the wrap member 640 in this embodiment. As the duct (pipe 611) is advanced into the compression connector 615 beyond the internal seal outlet 632f and the external seal outlet 633f, the end of the duct (pipe 7611) (and the wrap member 640) is forced against the radial support members 634d. As the duct (pipe 611) is advanced even further, the duct (pipe 611) (and the wrap member 640) causes the radial support members 634d to deform radially outward and longitudinally as well, so that the radial support members 634d also hold the duct (pipe 611) radially centered in the compression connector 615 as the pipe 611 continues its travel into the compression connector 615. The pressure exerted by the internal support tab members 631b, the seal support members 634c, and the radial support members 634d may also operatively hold the internal seal member 632 and the external seal member 633 and the duct (pipe 611) operatively in place relative to one another and the casing member 620. As illustrated in operation of the variable connecting member 650 and pipe 612, the longitudinal displacement of the radial support members 654d also preferably causes them to engage the threads 612c on the duct (pipe 612) in cases where threads 612a are present, acting as an even greater restraining force to operatively hold the duct (pipe 612) in place. Referring again to FIG. 10A through FIG. 15C and FIG. 17B as an example, in other embodiments, all or any combination of the internal support structure 631, 651 or the external support structure 634, 654 or both (which are described in more detail above and illustrated in connection with FIG. 10B through FIG. 15C) may be used to hold the ducts (pipes 611, 612) operatively in place in the compression connector 615. In embodiments of the compression connector 615 that comprise duct end support members 634e, 654e, the duct (pipe 611, 612) may be inserting into the compression connector 615 until the distal end of the duct (pipe 611, 612) abuts against the duct end support members 634e, 654e. When the compression connector 615 is no longer needed for connecting to the duct (pipes 611, 612), the variable connecting member 630, 650 may be removed from the casing member 620, the portions of the external support shell member 634b, 654b, respectively, may be pulled radially outward, releasing the radially inward pressure of the seal support members 634c, 654c and the radial support members 634d, 654d against the duct (pipes 611, 612), and the duct (pipes 611, 612) may then be removed from the variable connecting member 630, 650, respectively.

In some cases, as illustrated by the variable connecting member 650 and pipe 612 as an example, where the device 610 is operating at relatively high pressures (i.e., higher pressures in the chamber 660) or where only minimal contact may be present between the internal seal member 652 and the external seal member 653, on the one hand, and the exterior surface of the duct (pipe 612), on the other hand, because of minimum duct (pipe 612) size, supplemental duct sealing means may be utilized to provide or enhance the seal between the internal seal member 652 and the external seal member 653 and the duct (pipes 612). Examples of such means include adhesive, glue, epoxy or other joining compound or a combination of such means that is stored in a container or other receptacle, such as tube 678 illustrated in FIG. 17B. Generally, the user of the device 610 removes the lid from the container 678, places some of the adhesive from the container 678 on the exterior portion of the duct (pipe 612) at the end thereof or on the interior surface of the internal seal member 652 or the interior surface of the external seal member 653 where contact with the duct (pipes 612) is anticipated or on a combination of such surfaces. The duct (pipes 612) is then inserted into the compression connector 615 in the manner described above, preferably with a twisting motion. As the duct (pipes 612) is inserted, the adhesive is spread over the adjacent surfaces so that a film or layer of adhesive 679 is created between the internal seal member 652 and the external seal member 653 and the duct (pipes 612). It should be noted that before the adhesive sets, it may also act as a lubricant, allowing the duct (pipe 612) to be more easily inserted into the internal seal member 652 and the external seal member 653. The adhesive film 679 may provide for a relatively permanent attachment of the internal seal member 652 and the external seal member 653 to the duct (pipe 612), so that the internal seal member 652 and the external seal member 653 are not easily removed from the duct (pipe 612). An example of this type of adhesive is Cyanoacrylate (methyl-2-cyanoacrylate), which may be typically sold under the trademark SUPERGLUE. Alternatively, the adhesive film 679 may provide for non-permanent attachment of the internal seal member 652 and the external seal member 653 to the duct (pipe 612), so that the internal seal member 652 and the external seal member 653 are relatively easily removed from the duct (pipe 612) after use of the device 610 is completed. An example is an adhesive similar to rubber cement made from a polymer (such as latex) mixed in a solvent such as acetone, hexane, heptane or benzene to keep the polymer fluid prior to use. In addition, the supplemental duct sealing means of the present invention may comprise any of the supplemental duct sealing means (including use of adhesive layers with peel-off strips) disclosed in U.S. Nonprovisional patent application Ser. No. 11/879,346, and U.S. Provisional Patent Application No 60/______, entitled DEVICE FOR CONNECTING TO DUCTS OF VARIOUS SIZES AND SHAPES, filed on Jan. 25, 2008, the entire disclosures of which are incorporated herein by this reference.

Referring again to the variable sealing member 650 of FIG. 17B as an example, after the supplemental duct sealing means, if any, has been used to seal the duct (pipe 612) to the compression connector 615, fluids may be transmitted from the interior space 612b of the duct (pipe 612) to the interior space 611b of the duct (pipe 611) connected to variable sealing member 630, or vice versa, in a manner that provides a fluid-tight seal between the ducts (pipes 611, 612). When the fluid in the compression connector 615 and pipes 611, 612 is operating under pressure and there is little resistance to the flow of fluids in the pipes 611, 612, there is not a relatively great pressure (or thrust) loading along the longitudinal axis of the compression connector 615 tending to push the pipes 611, 612 away from the compression connector 615. As pressure builds within the interior space 611b, 612b of the pipes 611, 612, respectively, such as when a valve (not illustrated) is closed on the pipe 611 (when flow is from pipe 612 to pipe 611), the thrust loading along the longitudinal axes of the pipes 611, 612 and the compression connector 615 also increases. As the pressure in the interior space 611b, 612b of the pipes 611, 612, respectively, increases, the increasing fluid pressure is also transmitted to the chamber 660 as fluid flows or is compressed into the chamber 660 bounded by the case body 621, the internal seal member 632 and the external seal member 633 of the variable connecting member 630, the internal seal member 652 and the external seal member 653 of the variable connecting member 640, and the variable member connecting means (washers 635, 655). As the pressure builds in the chamber 660, increasing pressure is also exerted against the exterior surfaces 652d, 653d of the internal seal member 52 and the external seal member 33. The increasing pressure on the internal seal member 652 and the external seal member 653 also produces a radially inward force against the exterior surface of the duct (pipe 612), tending to operatively hold the pipe 612 in place relative to the compression connector 615 by friction. This radially inward force is also adapted to assist in maintaining a fluid-tight seal between the duct (pipe 612) and the internal seal member 652 and the external seal member 653 of the compression connector 615 in spite of the increasing thrust load. The internal support structure 651 also acts to operatively hold the duct (pipe 612) and the internal seal member 652 and the external seal member 653 in place relative to one another, the casing member 620, and the external support structure 654, so that the internal seal member 652 and the external seal member 653 do not undergo excessive deformation in the longitudinal direction when thrust loads increase. In addition, the external support structure 654 also acts to operatively hold the duct (pipe 612) and the internal seal member 652 and the external seal member 653 in place relative to one another, the casing member 620, and the internal support structure 651, so that the internal seal member 652 and the external seal member 653 do not undergo excessive deformation in the longitudinal direction when thrust loads increase. Further, as thrust loads begin to push the duct (pipe 612) out of the compression connector 615, the wrap means (wrap member 641, acting as thrust load restraint means in this embodiment) abuts against the radial support members 654d (and thus, abuts against the compression member of the compression connector 615), which hold the duct (612) operatively in place relative to the compression connector 615. In “operatively” holding in place the internal seal member 652, the external seal member 653, the internal support structure 651, the external support structure 654, the casing member 620, and the duct (pipe 612), it is anticipated that the internal seal member 652, the external seal member 653, the internal support structure 651, the external support structure 654, the casing member 620, and the duct (pipe 612) may change position somewhat relative to one another, but not an amount great enough to cause failure of the compression connector 615 within its designed operating parameters.

Thus, as is apparent from the foregoing description, the preferred type and structure of internal support structure 651, internal seal member 652, external seal member 653, external support structure 654, and variable connecting member support means, as well as other structural characteristics of the compression connector 615, are dependent upon numerous different factors. A compression connector 615 having a particular combination of features appropriate for one type of operating condition may not be appropriate for other types of operating conditions.

The present invention also includes kits (not directly illustrated) that comprise various combinations of components of the present invention, such components being described in more detail elsewhere herein. For example, as best illustrated in FIG. 1A, a kit may comprise any embodiment of the compression connector 15, any embodiment of the wrap means (wrap member 40), and any embodiment of the wrap connecting means, or any combination comprising one or more of the same. As another example, as best illustrated in FIG. 10B and FIG. 17B, a kit may also comprise one or more variable connecting means (variable connecting members 630, 650 in the illustrated embodiment), which are described in more detail above and illustrated in connection with FIG. 10A through FIG. 17B, in combination with any embodiment of the wrap means (wrap member 640, 641 in this embodiment) and the casing member 620, or any combination of one or more of the same. As another example, a kit may comprise all or any portion of the various components comprising the variable connecting means (variable connecting members 630, 650 in the illustrated embodiment), which are described in more detail above and illustrated in connection with FIG. 10A through FIG. 17B, and the wrap means (wrap member 640, 641 in this embodiment) and the wrap connecting means. As yet another embodiment, a kit may comprise one or more of the following: any embodiment of the variable connecting means (variable connecting members 630, 650 in the illustrated embodiment), any embodiment of the compression connector 615, any embodiment of the wrap means and wrap connecting means, and any embodiment of the supplemental duct sealing means (which are described in more detail above and illustrated in connection with FIG. 17B), such as a container 678 (see FIG. 17B) containing adhesive.

What is claimed is:

1. A device for use with a compression connector and a duct that is adapted to be connected to the compression connector, the device comprising a wrap member that is adapted to be positioned on and connected to a portion of the exterior surface of the duct, wherein the compression connector is further comprised of a compression member that is adapted to form a fluid-tight seal between the compression connector and the duct, and a portion of the wrap member abuts against a portion of the compression member in a manner that is adapted to hold the duct in place relative to the compression connector against thrust loads created when pressure is present in the compression connector and the duct.

2. The device of claim 1, wherein the wrap member is comprised of a semi-rigid polymer material.

3. The device of claim 1, wherein the duct exterior surface has a size and shape within a predetermined range, and the wrap member is adapted so that it may be positioned on the exterior surface of ducts within such range.

4. The device of claim 1, wherein the wrap member does not extend all the way around the periphery of the exterior surface of the duct.

5. The device of claim 1, wherein the wrap member is comprised of a ribbon that is further comprised of a semi-rigid portion, and the ribbon is adapted to be positioned on the exterior surface of the duct by wrapping the ribbon around all or a portion of the periphery of the duct.

6. The device of claim 1, further comprising the compression connector or the duct.

7. A method of using the device of claim 1, the method comprising in any order:
(a) positioning the compression member on the duct; and
(b) connecting the wrap member to the exterior surface of the duct.

8. A device for connecting to a duct, the device comprising:
(a) a compression connector that is further comprised of a compression member that is adapted to be positioned against and compressed against the exterior surface of the duct;
(b) wrap means adapted for:
(i) holding the duct in place relative to the compression connector against thrust loads created when pressure is present in the compression connector and the duct; or
(ii) being positioned between a portion of the exterior surface of the duct and all or a portion of the compression member so that a fluid-tight seal is adapted to be made between the exterior surface of the duct, the wrap member, and the compression member; or
(iii) both (i) and (ii), above; and
(c) wrap connecting means for connecting the wrap means to a portion of the exterior surface of the duct.

9. The device of claim 8, wherein the wrap means is comprised of at least two layers.

10. The device of claim 8, wherein the compression connector is comprised of variable connecting means, the duct exterior surface has a size and shape within a predetermined range, and the duct is adapted to be connected to the variable connecting means.

11. A device for use with a compression connector and a duct that is adapted to be connected to the compression connector, the device comprising:
(a) wrap means adapted for holding the duct in place relative to the compression connector against thrust loads created when pressure is present in the compression connector and the duct; and
(b) wrap connecting means for connecting the wrap means to a portion of the exterior surface of the duct.

12. The device of claim 11, wherein the wrap means are comprised of a semi-rigid polymer material.

13. The device of claim 11, wherein the wrap means are comprised of a ribbon, which is further comprised of a semi-rigid portion and is adapted to be positioned on a portion of the exterior surface of the duct by wrapping the ribbon around all or a portion of the periphery of the duct.

14. The device of claim 11, wherein the wrap means are comprised of a collar member that is adapted to be positioned on a portion of the exterior surface of the duct by sliding the collar member over the end of the duct.

15. The device of claim 11, wherein the wrap connecting means are comprised of an adhesive.

16. The device of claim 11, wherein the wrap connecting means are comprised of an adhesive tape with a peal-off strip.

17. The device of claim 11, further comprising the compression connector.

18. A method of using the device of claim 11, the method comprising connecting the wrap means to a portion of the exterior surface of the duct using the wrap connecting means.

19. A kit for use with the compression connector of claim 11, the kit comprising the wrap means and the wrap connecting means of claim 11.

20. A device for use with a compression connector and a first duct that is adapted to be connected to the compression connector, the device comprising a wrap member that is adapted to be positioned on and connected to a portion of the exterior surface of the first duct, wherein:
(a) the compression connector is further comprised of a compression member that is adapted to be positioned on and compressed against the exterior surface of at least one second duct having an outside cross-sectional perimeter larger than that of the first duct; and
(b) the wrap member is positioned between a portion of the exterior surface of the first duct and all or a portion of the compression member in a manner adapted to create a fluid-tight seal between the exterior surface of the first duct, the wrap member, and the compression member.

21. The device of claim 20, wherein the wrap member is comprised of a ribbon that is adapted to be positioned on the exterior surface of the first duct by wrapping the ribbon around all or a portion of the perimeter of the first duct.

22. The device of claim 20, wherein the wrap member is comprised of a collar member that is adapted to be positioned on the exterior surface of the first duct by sliding the collar member over the end of and along the longitudinal axis of the first duct.

23. The device of claim 20, further comprising the compression connector or the duct.

24. A method of using the device of claim 20, the method comprising positioning the wrap member on a portion of the exterior surface of the first duct and then positioning all or a portion of the compression member adjacent to all or a portion of the wrap member.

25. The device of claim 20, wherein the wrap member is also adapted to be positioned on a portion of the exterior surface of the first duct so that a portion of the wrap member abuts against a portion of the compression connector in a manner that is adapted to hold the first duct in place relative to the compression connector against thrust loads created when pressure is present in the compression connector and the first duct.

26. A kit comprising the wrap member and the compression connector of claim 20.

27. A device for use with a compression connector and duct that is adapted to be connected to the compression connector, wherein the compression connector is further comprised of a compression member that is adapted to be positioned on and compressed against the exterior surface of the duct, the device comprising:
(a) size adjusting means adapted for being positioned between a portion of the exterior surface of the duct and all or a portion of the compression member so that a fluid-tight seal is adapted to be made between the exterior surface of the duct, the wrap member, and the compression member; and
(b) wrap connecting means for connecting the size adjusting means to a portion of the exterior surface of the first duct.

28. The device of claim 27, wherein the size adjusting means are comprised of a ribbon that is adapted to be positioned on a portion of the exterior surface of the duct by wrapping the ribbon around all or a portion of the periphery of the duct.

29. The device of claim 27, wherein the wrap connecting means are comprised of an adhesive.

30. The device of claim 27, wherein the wrap connecting means are comprised of an adhesive tape with a peal-off strip.

31. A kit for use with the compression connector of claim 27, the kit comprising the size adjusting means and the wrap connecting means of claim 27.

32. A device for connecting to at least one duct, the at least one duct comprising a duct open end and a duct exterior surface adjacent to the duct open end having a size and shape within a predetermined range, the device comprising:
(a) a casing member having a casing interior space and at least one casing duct opening adjoining the casing interior space;
(b) a variable connecting member positioned approximately within the at least one casing duct opening, wherein the variable connecting member is further comprised of:
(i) duct sealing means adapted for changing shape to conform to the shape of and being positioned adjacent to the duct exterior surface while the at least one duct is connected to the device; and
(ii) seal support means positioned in the vicinity of the duct sealing means and being adapted for permitting a portion of the duct sealing means to change shape to conform to the shape of the duct exterior surface and adapted for holding the duct sealing means, the case body, and the at least one duct operatively in place relative to one another while the at least one duct is connected to the device;
(c) variable member connecting means for permanently or removably connecting the variable connecting member to the casing member;
(d) wrap means adapted for:
(i) holding the at least one duct in place relative to the casing member against any thrust loads created when pressure may be present in the casing member and the at least one duct; or
(ii) being positioned between a portion of the exterior surface of the at least one duct and all or a portion of the duct sealing means so that a fluid-tight seal is adapted to be made between the exterior surface of the at least one duct, the wrap member, and the duct sealing means; or
(iii) both (d)(i) and (d)(ii), above; and
(e) wrap connecting means for connecting the wrap means to a portion of the exterior surface of the at least one duct.

33. The device of claim 32, further comprising supplemental duct sealing means adapted for providing a fluid-tight seal between the at least one duct and the duct sealing means.

34. A kit for use with the casing member of claim 32, the kit comprising the variable connecting member, the wrap means, and the wrap connecting means of claim 32.
